(19) United States
(12) Patent Application Publication
(10) Pub. No.: US 2015/0027990 A1
(43) Pub. Date: Jan. 29, 2015

(54) HOLDING APPARATUS, HOLDING METHOD THEREOF, WIRE ELECTRICAL DISCHARGE MACHINING APPARATUS, AND MACHINING METHOD THEREOF

(71) Applicant: CANON MARKETING JAPAN KABUSHIKI KAISHA, Minato-ku, Tokyo (JP)

(72) Inventor: Takayuki Yagashiro, Aiko-gun (JP)

(21) Appl. No.: 14/338,046

(22) Filed: Jul. 22, 2014

(30) Foreign Application Priority Data
Jul. 25, 2013 (JP) 2013-155069
Nov. 25, 2013 (JP) 2013-243400
Apr. 28, 2014 (JP) 2014-092913

(51) Int. Cl. B23H 11/00; B23H 7/02; B28D 5/00; B23H 1/00

(52) U.S. Cl. CPC B23H 11/003; B23H 1/00; B23H 7/02; B28D 5/0082
USPC 219/69.12; 219/158

(57) ABSTRACT

A holding apparatus, which is used in electrical discharge machining for cutting a workpiece into slices at intervals of wires arranged in parallel to each other, includes: a holding unit for holding the workpiece so as to prevent the workpiece from falling from the holding apparatus; and an energization unit for energizing the workpiece so as to pass current through the workpiece. The holding unit is disposed outside a place at which the wires and the holding unit interfere with each other. The energization unit is disposed at a place at which the cutting of the workpiece into slices by the wires ends. A portion of the energization unit, which is brought into contact with the workpiece at the place at which the cutting of the workpiece into slices ends, has a surface shape that is prevented from conforming to a machining surface of the workpiece.

### BACKGROUND OF THE INVENTION

1. Field of the Invention

The present invention relates to a holding apparatus, a holding method thereof, a wire electrical discharge machining apparatus, and a machining method thereof.

2. Description of the Related Art

Hitherto, a wire saw is known as an apparatus for cutting a silicon ingot into a plurality of thin slices. In recent years, there is a technology for cutting a workpiece into thin slices by using a wire electrical discharge machining technology.

For example, in Japanese Patent Application Laid-Open No. H10-340869, there is disclosed a technology in which, in a wire saw, a protective member for preventing a chip at the end of cutting an ingot, which is called a slice base, is bonded with an adhesive to a side portion of the ingot, and then, the slice base bonded to the ingot is bonded with an adhesive to a mounting tool to a workpiece feed table, which is called a mounting plate. The mounting plate to which the ingot is bonded is mounted to a workpiece holding unit of the workpiece feed table to mount the ingot to the workpiece feed table. The ingot is cut until the wire saw reaches the slice base.

For example, in Japanese Patent Application Laid-Open No. 2000-107941, it is disclosed that, in wire electrical discharge machining for cutting a workpiece into slices with a plurality of wires, a slice base extending in an axial direction of the workpiece is bonded with a conductive adhesive to a part in a circumferential surface of the workpiece formed of a conductive material such as low resistance silicon. Further, in Japanese Patent Application Laid-Open No. 2000-107941, there is disclosed a technology of using a material which is equivalent to that of a workpiece for a slice base and a technology of simultaneously cutting the workpiece into a plurality of wafers by feeding for the cutting until portions of wires used for the cutting reach the slice base or until the portions cut the slice base.

When an ingot is machined with an electrical discharge multi-wire saw, there are several methods of holding the ingot to be machined. In these methods, it is necessary to stably supply electricity (energization) for electrical discharge machining of the ingot to be machined and to hold the sliced wafers until the machining ends.

When a method of holding an ingot using a conductive beam is used, an adhesive is necessary at a border surface between the ingot and the beam in order to hold the ingot. In addition, a material of the adhesive is required to be conductive in order to stably supply electricity (energization) for electrical discharge machining.

At that time, when, as illustrated in FIGS. 9A to 9D, a material of the ingot (silicon or the like) and a material of the beam (aluminum or the like) which are different from each other exist in a mixed manner, in a region where the ingot and the beam are simultaneously subjected to electrical discharge machining, the resistance value of the material of the beam (aluminum or the like) and the resistance value of the material of the ingot (silicon or the like) are different from each other, and thus, due to the difference in resistance value, places through which the electricity passes may become unstable to break the wire. In other words, in order to prevent the wire from being broken, electrical discharge machining is required to be performed under a state in which the material of the ingot (silicon or the like) and the material of the beam (aluminum or the like) do not exist in a mixed manner.

### SUMMARY OF THE INVENTION

Accordingly, the present invention provides a mechanism which can eliminate a region where an ingot and an ingot holding unit that are formed of materials different from each other exist in a mixed manner as electrical discharge machining proceeds in a region where the electrical discharge machining proceeds while the ingot is held so as not to fall. The mechanism can reduce instability of the electrical discharge machining due to simultaneous discharge with regard to the ingot and the ingot holding unit that are formed of materials different from each other to prevent wires from being broken.

According to one embodiment of the present invention, there is provided a holding apparatus, which is used in electrical discharge machining for cutting a workpiece into slices at intervals of wires arranged in parallel to each other, the holding apparatus including: a holding unit for holding the workpiece so as to prevent the workpiece from falling from the holding apparatus; and an energization unit for energizing the workpiece so as to pass current through the workpiece, in which: the holding unit is disposed outside a place at which the wires and the holding unit interfere with each other; the energization unit is disposed at a place at which the cutting of the workpiece into slices by the wires ends; and a portion of the energization unit, which is brought into contact with the workpiece at the place at which the cutting of the workpiece into slices ends, has a surface shape that is prevented from conforming to a machining surface of the workpiece which is cut into slices.

Further features of the present invention will become apparent from the following description of exemplary embodiments with reference to the attached drawings.

### BRIEF DESCRIPTION OF THE DRAWINGS

FIG. 1 is a front view of a multi-wire electrical discharge machining system according to the present invention.

FIG. 2 is an enlarged front view of a multi-wire electrical discharge machining apparatus according to the present invention.

FIG. 3 shows interelectrode states (voltage and current) and pulse (ON/OFF) periods of machining currents according to the present invention.

FIG. 4 illustrates a layout of an electric circuit and various components according to the present invention.

FIG. 5 illustrates a layout of an electric circuit and various components according to the present invention.

FIGS. 6A, 6B and 6C illustrate a layout of various components of a holding apparatus (retaining unit) according to the present invention.

FIG. 7 is a front view illustrating relative positional relationship between the holding apparatus (retaining unit) and the multi-wire electrical discharge machining apparatus according to the present invention.

FIGS. 8A, 8B and 8C are front views illustrating change in relative position in machining between the holding apparatus (retaining unit) and the multi-wire electrical discharge machining apparatus according to the present invention.

FIGS. 9A, 9B, 9C and 9D illustrate a related-art method of holding an ingot.

FIGS. 10A, 10B and 10C illustrate shapes and a layout of components (side stays with claws) included in the holding apparatus according to the present invention.

FIGS. 11A, 11B and 11C illustrate shapes and a layout of components (side stays without claws) included in the holding apparatus according to the present invention.

FIGS. 12A, 12B, 12C, 12D, 12E, 12F and 12G illustrate a shape and a layout of a component (ingot retaining roller) included in the holding apparatus according to the present invention.

FIGS. 13A, 13B and 13C illustrate contact states between the ingot retaining roller and an ingot according to the present invention.

FIGS. 14A, 14B, 14C and 14D illustrate a shape and a layout of components (wafer retainers in a machining vessel) included in the machining vessel according to the present invention.

FIGS. 15A, 15B, 15C, 15D and 15E illustrate shapes and a layout of components (retainer support plates and a support block) included in the holding apparatus according to the present invention.

FIGS. 16A, 16B, 16C and 16D illustrate a shape and a layout of a component (base) included in the holding apparatus according to the present invention.

FIGS. 17A, 17B and 17C are side views illustrating change in relative position in machining between the holding apparatus (retaining unit) and the multi-wire electrical discharge machining apparatus according to the present invention.

FIGS. 18A, 18B, 18C, 18D, 18E, 18F, 18G and 18H illustrate modifications of a shape of an energization unit in relation to various kinds of machining surface shapes of an ingot according to the present invention.

FIGS. 19A, 19B, 19C and 19D illustrate an exemplary holding apparatus which accommodates a modification of the machining surface shape (frustum) of the ingot according to the present invention.

FIGS. 20A, 20B, 20C, 20D, 20E and 20F illustrate the holding unit which has slanted portions according to the present invention.

FIGS. 21A, 21B, 21C, 21D and 21E illustrate influence of a water flow on wires.

FIGS. 22A, 22B and 22C illustrate the holding unit which has extended portions according to the present invention.

FIG. 23 illustrates an exemplary holding apparatus which accommodates a modification of the machining surface shape (dome-shaped) of the ingot according to the present invention.

FIG. 24 illustrates the exemplary holding apparatus which accommodates the modification of the machining surface shape (dome-shaped) of the ingot according to the present invention.

FIG. 25 illustrates the exemplary holding apparatus which accommodates the modification of the machining surface shape (dome-shaped) of the ingot according to the present invention.

### DESCRIPTION OF THE EMBODIMENTS

Preferred embodiments of the present invention will now be described in detail in accordance with the accompanying drawings.

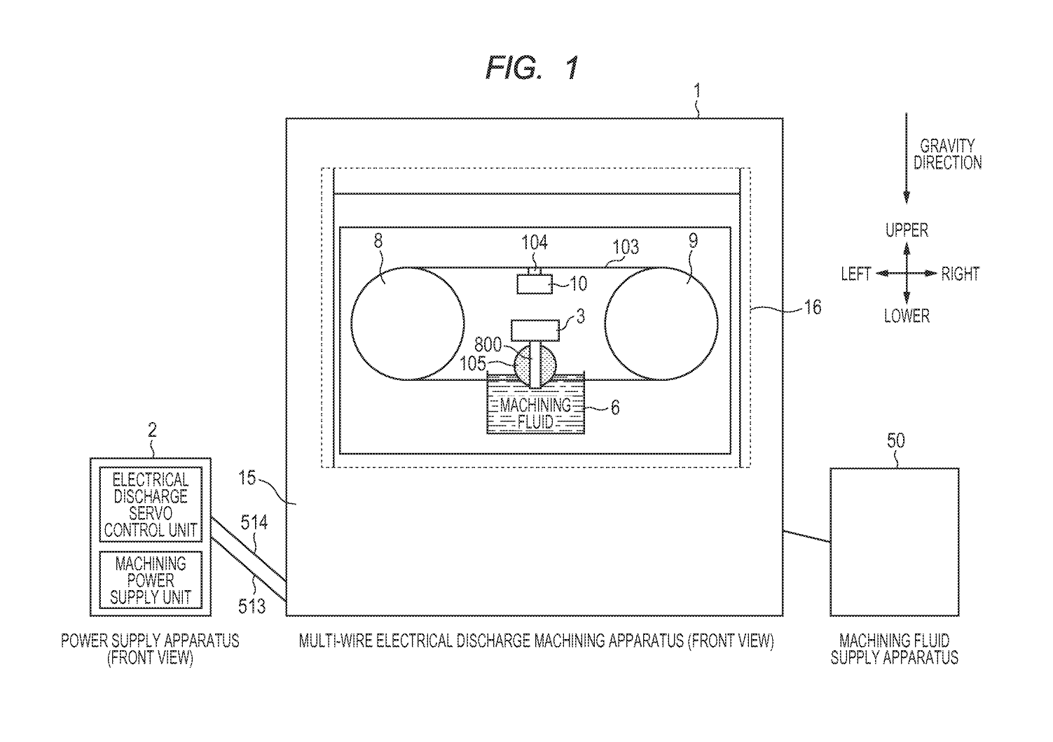

FIG. 1 is referred to for description. FIG. 1 is an external view of a multi-wire electrical discharge machining apparatus 1 viewed from front according to an embodiment of the present invention. It should be understood that the structure of mechanisms illustrated in FIG. 1 is an example, and there are various structural examples in accordance with objects and usages.

FIG. 1 illustrates a structure of a multi-wire electrical discharge machining system (a manufacturing system for semiconductor substrates or solar cell substrates) according to the present invention. The multi-wire electrical discharge machining system includes the multi-wire electrical discharge machining apparatus 1, a power supply apparatus 2, and a machining fluid supply apparatus 50. The multi-wire electrical discharge machining system can cut an object to be machined into thin slices by electrical discharge at an interval of a plurality of wires 103 arranged in parallel.

In the multi-wire electrical discharge machining apparatus 1, a workpiece feeding unit 3 driven by a servo motor is arranged above the wires 103 so that a workpiece 105 can be moved in up and down directions. In the present invention, the workpiece 105 is fed downward (in the gravity direction), and electrical discharge machining is performed between the workpiece 105 and the wire 103. In this specification, the up and down directions correspond to upward and downward directions in the gravity direction, respectively, and left and right directions correspond to leftward and rightward directions, respectively, when the multi-wire electrical discharge machining apparatus is viewed from the front.

An electrical discharge servo control circuit configured to control the servo motor is provided in the power supply apparatus 2. The electrical discharge servo control circuit controls an electrical discharge gap to be constant in order to efficiently generate electrical discharge in accordance with an electrical discharge state, and performs positioning of the workpiece so that the electrical discharge machining is proceeded.

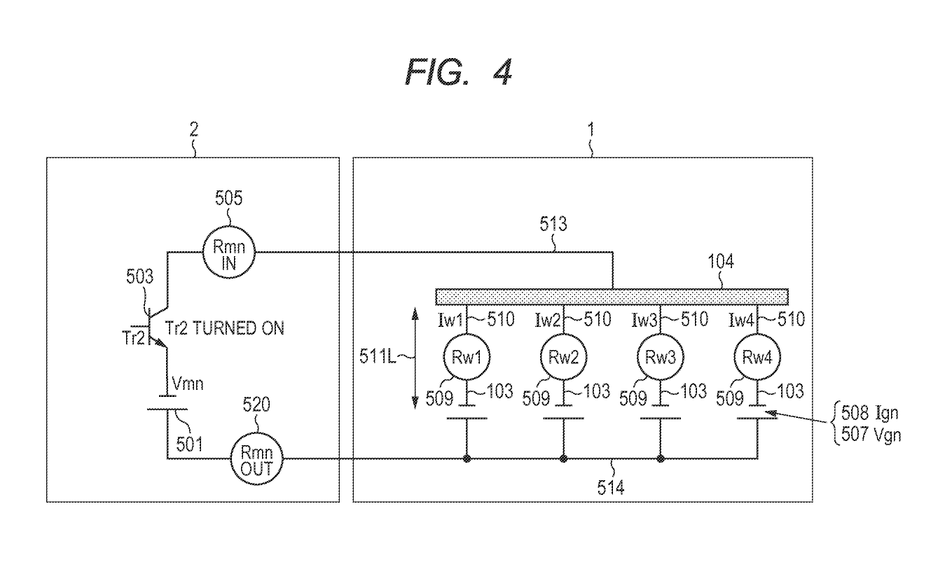

A machining power supply circuit (FIG. 4) applies an electrical discharge pulse for the electrical discharge machining to the wire 103, performs control for adapting to a state such as a short circuit occurring in the electrical discharge gap, and supplies the electrical discharge servo control circuit with an electrical discharge gap signal.

The machining fluid supply apparatus 50 supplies the workpiece 105 and the wire 103 with machining fluid necessary for cooling an electrical discharge machining portion and for removing machining chips (scraps) by a pump, removes the machining chip in the machining fluid, controls an electrical conductivity (1 μS/cm to 250 μS/cm) by ion exchange, and controls liquid temperature (at around 20° C.) Water is mainly used as the machining fluid, but it is possible to use electrical discharge machining oil.

In main rollers 8 and 9, a predetermined number of grooves are formed at a predetermined pitch so that the workpiece 105 can be cut so as to have a desired thickness. A tension-controlled wire 103 supplied from a wire supply bobbin winds around the two main rollers a necessary number of turns and is sent to a rewind bobbin. The driving speed of the wire 103 is approximately 100 m/min to 900 m/min. The main rollers function as a driving unit in which, by rotating the two main rollers together in the same direction at the same speed, one wire 103 sent from a wire feeding portion winds around outer peripheries of the two main rollers so as to drive the plurality of wires 103 arranged in parallel to run in the same direction.

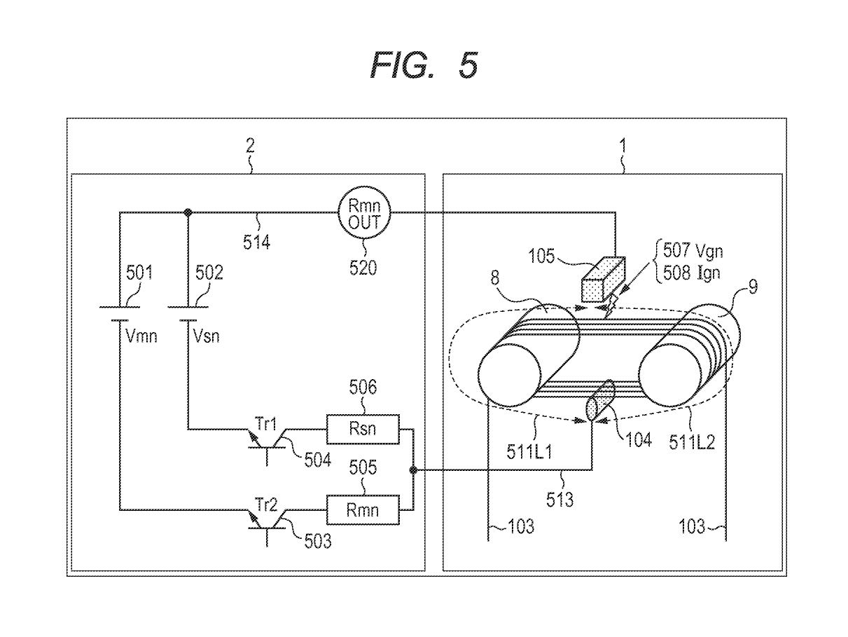

As illustrated in FIG. 5, the wire 103 as one continuous wire is sent out from a bobbin (not shown), fits in guide grooves (not shown) on the outer circumferential surfaces of the main rollers so as to wind around the outer circumferential surfaces of the main rollers a plurality of turns (approximately 2,000 turns at most) in a spiral manner, and then is rewound by the bobbin (not shown).

The multi-wire electrical discharge machining apparatus 1 is connected to the power supply apparatus 2 via electric wires 513 and operates by power supplied from the power supply apparatus 2. As illustrated in FIG. 1, the multi-wire electrical discharge machining apparatus 1 includes a block 15 functioning as a base of the multi-wire electrical discharge machining apparatus 1, and also includes, in the part above the block 15, the workpiece feeding unit 3, the workpiece 105, a machining vessel 6, the main roller 8, the wire 103, the main roller 9, a power supply terminal unit 10, and a batch power supply terminal 104.

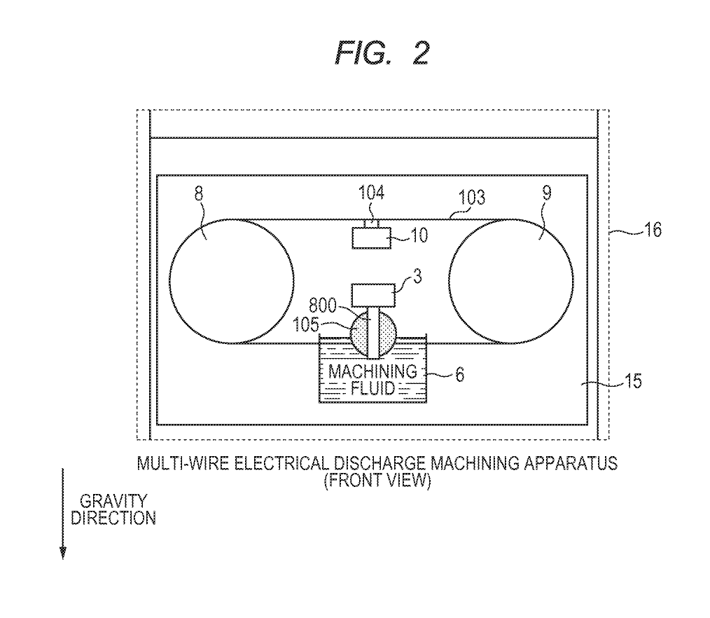

FIG. 2 is referred to for description. FIG. 2 is an enlarged view of a part in a dotted line frame 16 illustrated in FIG. 1.

The wire 103 winds around the main rollers 8 and 9 a plurality of turns so that the wires 103 are arranged at a predetermined pitch in accordance with the grooves formed in the main rollers 8 and 9. The main rollers 8 and 9 each have a structure including a metal core and a resin covering the core.

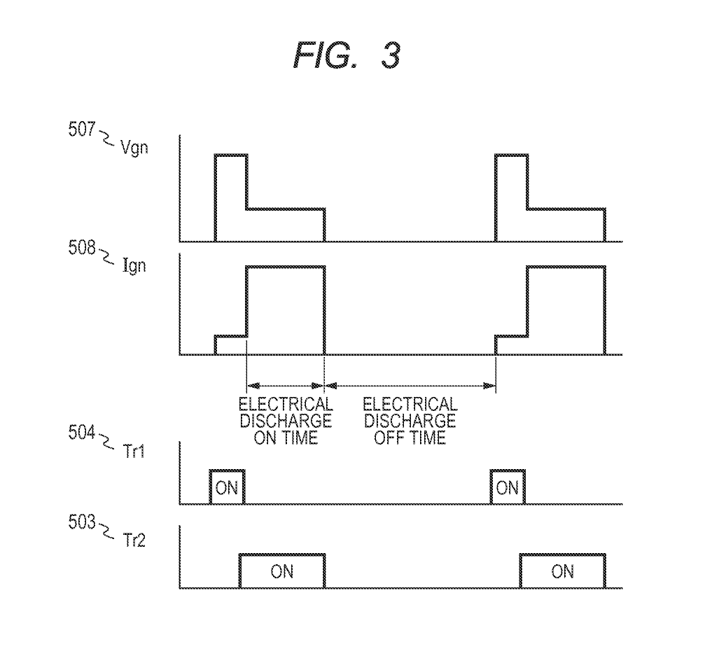

Between the two main rollers 8 and 9 and at a position above substantially the center of a space between the main rollers 8 and 9, the batch power supply terminal 104 mounted to the power supply terminal unit 10 is arranged. The batch power supply terminal 104 has an upper exposed surface, which contacts with the wire 103 so that a machining voltage is applied to the plurality of running wires 103 in a batch. The batch power supply terminal 104 contacts with ten of the wires 103 so as to supply an electrical discharge pulse (electrical discharge pulse of a transistor Tr2 503 in FIG. 3) from a machining power supply unit 501 to the ten wires 103. The batch power supply terminal 104 is arranged at such a position that lengths of the wire 103 from both ends of the workpiece 105 in the longitudinal direction of the wire are substantially equal to each other (511L1=511L2 in FIG. 5). The batch power supply terminal 104 is required to have high resistance to mechanical wear and electric conductivity, and is made of cemented carbide alloy.

Between the two main rollers 8 and 9 and at a position below substantially the center of the space between the main rollers 8 and 9, the workpiece 105 mounted to the workpiece feeding unit 3 is arranged. When the workpiece feeding unit 3 feeds the workpiece 105 downward, a slicing process is performed.

Below the main rollers, the machining vessel 6 is arranged, in which the wire 103 and the workpiece 105 are dipped into the machining fluid to cool the electrical discharge machining portion and remove machining chips. The machining vessel 6 is filled with the machining fluid in which the fed workpiece is dipped.

One batch power supply terminal 104 contacting with ten wires 103 is described. However, it should be understood that the number of wires contacting with one batch power supply terminal 104 and the total number of power supply terminals 104 contacting with the wire 103 wound around the main rollers approximately 2,000 turns at most in a spiral manner can be changed as necessary.

The block 15 is joined to the workpiece feeding unit 3. In addition, the workpiece feeding unit 3 causes the workpiece 105 to be cut into thin slices by driving the workpiece 105 held by a workpiece holding unit 800 to go down in the gravity direction.

In this embodiment, a silicon ingot is exemplified as a material to be machined (workpiece 105).

The workpiece holding unit 800 holds the workpiece feeding unit 3 and the workpiece 105. For instance, the workpiece holding unit 800 is formed of a conductive material. Note that, the workpiece holding unit 800 is removable as a workpiece holding tool when the workpiece 105 is appropriately set.

The workpiece feeding unit 3 is an apparatus including a mechanism for moving the workpiece 105 held by the workpiece holding unit 800 in the up and down directions. Downward movement (in the gravity direction) of the workpiece feeding unit 3 with the workpiece 105 held thereby enables the workpiece 105 to approach the wire 103.

By including an energization unit (ingot retaining roller) 814 which is included in the workpiece holding unit 800 in an electric circuit illustrated in FIG. 5, machining current which passes through the workpiece 105 in the electrical discharge machining can flow from a machining power supply unit 501 and a machining power supply unit 502 through the energization unit 814.

The workpiece feeding unit 3 is placed at a position lower than that of the batch power supply terminal 104. The workpiece feeding unit 3 feeds the workpiece 105 in the direction toward the wire 103 which is wound so that the workpiece 105 held by the workpiece feeding unit 3 is dipped in the machining fluid.

The machining vessel 6 is a container filled with the machining fluid and is arranged outside the wire 103 winding around the plurality of main rollers 8 and 9. The machining fluid is deionized water having a high resistance value, for example. The machining fluid is arranged between the wire 103 and the workpiece 105. The electrical discharge occurs between the wire 103 and the workpiece 105 so that the workpiece 105 can be cut.

The main rollers 8 and 9 are provided with a plurality of rows of grooves for winding the wire 103, and the wire 103 is fitted around the main rollers 8 and 9 along the grooves. When the main rollers 8 and 9 rotate in a left or right direction, the wire 103 runs. In addition, as illustrated in FIG. 2, the wire 103 is fitted around the main rollers 8 and 9 so as to form wire rows on the upper side and the lower side of the main rollers 8 and 9. In addition, the wire 103 is a conductor. When the batch power supply terminal 104 of the power supply terminal unit 10 supplied with a machining voltage from the power supply apparatus 2 contacts with the wire 103, the supplied machining voltage is applied from the batch power supply terminal 104 to the wire 103. In other words, the batch power supply terminal 104 applies the machining voltage to the wire 103.

Then, an electric discharge occurs between the wire 103 and the workpiece 105 so as to cut the workpiece 105 (electrical discharge machining is performed), and hence thin silicon plates (silicon wafers) can be produced.

FIG. 3 is referred to for description. FIG. 3 shows variations of an electrical discharge voltage (Vgn) and an electrical discharge current (Ign) at an interelectrode or an interelectrode space between the wire 103 and the workpiece 105, and ON/OFF operation (timing chart) of transistors Tr1 and Tr2 according to the present invention. The horizontal axis of the graph indicates time.

First, the transistor Tr1 504 is turned on, and the inducing voltage is applied. In this case, because the wire 103 and the workpiece 105 (interelectrode) are isolated from each other, the electrical discharge current at the interelectrode hardly flows. After that, when the electrical discharge current at the interelectrode starts to flow so that the electrical discharge starts, Vgn drops, and the start of the electrical discharge is detected so that the transistor Tr2 503 is turned on. Thus, a large interelectrode electrical discharge current is obtained. When a predetermined time elapses, the transistor Tr2 503 is turned off. When a predetermined time elapses from the turn-off of the transistor Tr2 503, the series of operation is repeated again.

FIG. 4 is referred to for description. FIG. 4 illustrates a relationship between the electric circuit of the power supply apparatus 2 and the wire electrical discharge machining apparatus 1 in a batch power supply method in which the machining current is supplied from the batch power supply terminal 104 to the plurality of (ten) wires in a batch. FIG. 4 illustrates a state where, because the transistor Tr2 503 is turned on, the machining current, that is, the wire current, and the electrical discharge current at the interelectrode are flowing. FIG. 4 illustrates an equivalent circuit to the electric circuit illustrated in FIG. 5.

When an electric circuit of a typical individual power supply method is introduced to the electric circuit of the batch power supply method in which the machining current is supplied to the plurality of (ten) wires in a batch, in order to control the upper limit of the machining current between the machining power supply unit and the power supplying point, a current limiting resistor (Rm) having a fixed resistance value may be arranged between the machining power supply unit 501 and the power supplying point, so as to supply the machining current of total (ten times) of a current flowing through each wire 103, which is supplied to the plurality of (ten) wires.

First, description is made of a case where the current limiting resistor (Rm) having the fixed resistance value is arranged between the machining power supply unit 501 and the batch power supply terminal 104. When the current limiting resistor (Rm) is arranged, if the electrical discharge occurs uniformly and simultaneously between the workpiece 105 and all the ten wires 103, the machining current is distributed uniformly among the ten wires 103 so that machining current corresponding to the fixed resistance value (Rm) is supplied to each wire 103. Therefore, supply of an excess machining current is not a problem in each wire 103.

However, when the current limiting resistor (Rm) is arranged, if the electrical discharge does not occur uniformly and simultaneously between the workpiece 105 and all the ten wires 103, the machining current corresponding to the fixed resistance value (Rm) is supplied in a concentrated manner to the wire 103 in the electrical discharge state. Therefore, the supply of an excess machining current becomes a problem in each wire 103. In other words, if only one of the ten wires becomes the electrical discharge state, a machining current of ten times the machining current to be usually supplied to one wire 103 when the electrical discharge occurs uniformly and simultaneously is supplied only to the wire 103 in the electrical discharge state, and hence the wire 103 may be broken.

The wiring 513 has an impedance (resistance value) 505 of its internal resistance. The wiring 513 is a cable of the up line connected to a negative side of the machining power supply unit 501 (Vmn). The wiring 513 supplies the machining voltage from the machining power supply unit 501 to the batch power supply terminal 104.

A wiring 514 has an impedance (resistance value) 520 of its internal resistance. The wiring 514 is a cable of the down line connected to a positive side of the machining power supply unit 501 (Vmn).

To sufficiently reduce the resistance value Rmn 505 of the wiring 513 according to the present invention is different from limiting the machining current to a predetermined upper limit using the related-art current limiting resistor (Rm). The wire electrical discharge machining system according to the present invention includes a mechanism capable of controlling the resistance value so that the combined resistance value of the wire 103 is varied in accordance with the number of wires 103 in the electrical discharge state even if only one of the ten wires becomes the electrical discharge state.

In this way, according to the present invention, the resistance value Rmn 505 of the wiring 513 is set in a resistance value range sufficiently smaller than a resistance value Rwn 509 of the wire 103, and thus the combined resistance value of the wire 103 is varied in accordance with the number of wires 103 in the electrical discharge state. At this time, the resistance value Rwn 509 of the wire 103 becomes dominant over the resistance value Rmn 505 of the wiring 513 as a parameter for limiting the upper limit of the machining current, and thus the influence of the resistance value Rmn 505 of the wiring 513 can be almost neglected. Therefore, in the present invention, it is not necessary to provide the current limiting resistor (Rm) for limiting the upper limit of the machining current, which flows from the machining power supply unit 501 to the batch power supply terminal 104 and becomes the electrical discharge current of the electrical discharge to the workpiece 105 in the interelectrode. In the present invention, the resistance value Rmn only needs to be smaller than the resistance value obtained by simply dividing the resistance value Rwn 509 by the number (ten) of times for which the wire winds around the main rollers 8 and 9.

In other words, by using the impedance which is the resistance Rwn 509 of each wire 103 instead of the current limiting resistor (Rm) as the parameter for limiting the upper limit of the machining current, a wire current Iwn is stably supplied to each wire 103, and hence, concentration of the machining current to the wire 103 is prevented.

The resistance value Rwn 509 is a resistance value of each wire. Here, the resistance value of the wire 103 from the batch power supply terminal 104 to the electrical discharge portion means a resistance value due to a length of the wire 103 (one wire) running from a contact point with the batch power supply terminal 104 to the electrical discharge portion. For example, resistance values of ten wires (wound ten turns around the main rollers 8 and 9) of the wire 103 are denoted by Rw1, Rw2, . . . , and Rw10, respectively, when power is supplied to the ten wires in a batch.

Instead of using the resistance value Rm as the resistance for limiting the total value of the wire current (Iw) and the electrical discharge current (Ig) of one wire as in a typical individual power supply method, the resistance value Rwn is used as a resistance for limiting the wire current (Iwn) and the electrical discharge current (Ign) of one wire so that the wire current (Iwn) and the electrical discharge current (Ign) of one wire can be limited.

By changing a distance (length L) between the power supplying point (batch power supply terminal 104) and the electrical discharge point (electrical discharge portion), the resistance value Rwn 509 can be set to be an arbitrary resistance value. For example, when Vmn=60 V, Vgn=30 V, and Rwn=10Ω, Iwn (Ign)=(60 V−30 V)/10 Ω=3 A. Note that, in the above equation, a voltage drop from the power supplying point to the electrical discharge point due to the wire resistance value (Rwn) is assumed to be 30 V. However, a voltage drop from the power supplying point to the electrical discharge point due to the resistance (Rmn) causing a voltage drop from the machining power supply unit 501 to the power supplying point is not considered.

In other words, in order to prevent concentration of the machining current on the wire 103 in the wire electric discharge machining system of the batch power supply method of the present invention, the wire current Iwn is determined by the wire resistance value Rwn. Therefore, in order to obtain a desired wire current (Iwn) and an electrical discharge current (Ign) for each wire, the resistance Rmn causing the voltage drop from the machining power supply unit 501 to the power supplying point is set to satisfy the relationship of Rmn<<Rwn.

In addition, the wire resistance value Rwn of each wire is determined by the relationship equation of Rwn=(ρ×L)/B using three parameters, which are (1) an electrical resistivity ρ depending on a material of the wire 103, (2) a cross-sectional area B of the wire 103, and (3) a length L of the wire 103.

The machining power supply unit 501 supplies the machining voltage Vmn set in order to supply a machining current necessary for electric discharge machining. The machining power supply unit 501 can set the machining voltage Vmn to an arbitrary machining voltage. Further, because the machining current supplying amount becomes larger than that in the typical individual power supply method, the machining power supply unit 501 requires a capacity for supplying a power larger than that of the machining power supply unit of the typical individual power supply method. The machining power supply unit 501 supplies the machining voltage Vmn to the batch power supply terminal 104.

The machining power supply unit 502 supplies an inducing voltage Vsn set to induce the electrical discharge. The machining power supply unit 502 further monitors a state of the electrical discharge voltage (electrical discharge current) between the wire 103 and the workpiece 105, which is used for controlling the workpiece feeding unit 3. The machining power supply unit 502 can set the inducing voltage Vsn to an arbitrary inducing voltage. Further, because the inducing current supplying amount becomes larger than that of the typical individual power supply method, the machining power supply unit 502 requires a capacity for supplying a power larger than that of the machining power supply unit of the typical individual power supply method. The machining power supply unit 502 supplies the inducing voltage (Vsn) to the batch power supply terminal 104.

The transistor 503 (Tr2) switches between an ON (conductive) state and an OFF (nonconductive) state of the machining voltage Vmn. The transistor 504 (Tr1) switches between an ON (conductive) state and an OFF (nonconductive) state of the machining voltage Vsn.

An electrical discharge voltage 507 (Vgn) at the interelectrode is an electrical discharge voltage applied between the wire 103 and the workpiece 105 during the electrical discharge. For instance, electrical discharge voltages when supplying power to the ten wires in a batch are denoted by Vg1, Vg2, . . . , and Vg10. The electrical discharge portion is a portion to which the electrical discharge voltage is applied between the wire 103 and the workpiece 105 by the electrical discharge. At the electrical discharge portion, with the machining voltage, which is supplied to the plurality of running wires 103 in a batch by the contact between the batch power supply terminal 104 and the plurality of running wires 103, the workpiece 105 is subjected to electrical discharge.

An electrical discharge current 508 (Ign) at the interelectrode is an electrical discharge current flowing between the wire 103 and the workpiece 105 during the electrical discharge. For instance, electrical discharge currents when supplying power to the ten wires in a batch are denoted by Ig1, Ig2, . . . , and Ig10. The electrical discharge portion is a portion to which the electrical discharge current flows between the wire 103 and the workpiece 105 by the electrical discharge. At the electrical discharge portion, with the machining voltage, which is supplied to the plurality of running wires 103 in a batch by the contact between the batch power supply terminal 104 and the plurality of running wires 103, the workpiece 105 is subjected to electrical discharge.

A wire current 510 (Iwn) is a wire current individually supplied for each of the wires. For instance, when the power is supplied to the ten wires in a batch, the wire currents are denoted by Iw1, Iw2, . . . , and Iw10.

A distance 511 is the distance L from the power supplying point to the electrical discharge point, that is, the length of the wire 103 from the power supplying point (batch power supply terminal 104) to the electrical discharge point (workpiece 105).

FIG. 5 is referred to for description. FIG. 5 illustrates that the power is supplied to the plurality of wires 103 in a batch by the electric circuit in the power supply apparatus 2 having the batch power supply method of the present invention in which the machining current is supplied to the plurality of (ten) wires in a batch. Further, it should be noted that a structural layout of the multi-wire electrical discharge machining apparatus 1 illustrated in FIG. 5 is different from a structural layout of the multi-wire electrical discharge machining apparatus 1 illustrated in FIG. 1, but the electrical structures are the same.

The batch power supply terminal 104 contacts with the plurality of running wires 103 in a batch. The electrical discharge pulse is applied from the batch power supply terminal 104 arranged at one portion opposed to the workpiece 105 so as to perform the electrical discharge machining.

One power supply circuit is connected to the plurality of (ten) wires 103 winding around the main rollers 8 and 9.

Now, with reference to the layout of FIG. 5, description is made of the machining current flowing in the wires 103 (total current of the wire currents).

As illustrated in FIG. 5, the wire current flowing from the power supplying point (at which the batch power supply terminal 104 contacts with the wire 103) to the electrical discharge point (between the wire 103 and the workpiece 105) flows through two paths via the left and right main rollers 8 and 9, and hence there is a wire resistance corresponding to each path.

The length (distance) 511L1 is a length between the power supplying point and the electrical discharge point when the current flows via the left main roller 8, and a wire resistance value determined when the length is L1 is denoted by Rw1a. The length (distance) 511L2 is a length between the electrical discharge point and the power supplying point when the current flows via the right main roller 9, and a wire resistance value determined when the length is L2 is denoted by Rw1b.

A length by which the wire 103 winds around the main rollers 8 and 9 one turn is assumed to be 2 m. Because the batch power supply terminal 104 is arranged at a distance of substantially half of the length of the wire winding around the main rollers one turn, the distance (wire length L) between the electrical discharge point and the power supplying point is 1 m. Here, the distance of the wire 103 running from the power supply terminal to the electrical discharge portion only needs to be longer than 0.5 m.

The main component of the material of the wire 103 is iron, and the diameter of the wire 103 is 0.12 mm (having a cross-sectional area of 0.06×0.06×π mm²). Because the wires have the same length (L1=L2=1 m), when the resistance values Rw1a and Rw1b of the wires 103 are set to the same value of approximately 20Ω, a combined wire resistance value of one wire (winding around the main rollers 8 and 9 one turn) constituted of Rw1a and Rw1b is approximately 10 Ω.

In addition, in order to set the wire resistance values of the lengths L1 and L2 illustrated in FIG. 5 to the same value, it is preferred to arrange the batch power supply terminal 104 so that the lengths L1 and L2 have the same value. However, there is no particular problem even if the batch power supply terminal 104 is arranged so that the lengths L1 and L2 are different from each other within a difference of approximately 10% (for example, L1 is 1 m while L2 is 1.1 m).

When the electrical discharge voltages Vg1 to Vg10 are substantially equal to each other, because Vmn is applied to each of Rw1 to Rw10, Iw1 to Iw10 are all the same wire current.

Here, Vmn is determined from the voltage drop value (Rw1×Iw1) due to the wire resistance value and the electrical discharge voltage (Vgn). The voltage drop from the batch power supply terminal 104 to the electrical discharge portion is a voltage drop due to the resistance value of the running wire. Here, when Rw1 is 10Ω (a resistance value from the batch power supply terminal 104 to the electrical discharge portion), Iw1 is 3 A, and Vgn is 30 V, Vmn is derived as follows: Vmn=10 (Ω)×3 (A)+30 V=60 V.

Here, the voltage drop from the batch power supply terminal to the electrical discharge portion only needs to be larger than 10 V. Further, the resistance value between the batch power supply terminal and the electrical discharge portion only needs to be larger than 1Ω. Further, from the relationship equation of Rwn=(ρ×L)/B, the voltage drop value due to the wire resistance value may be set based on the parameters of the wire 103.

Therefore, the resistance value Rmn when the electrical discharge state occurs uniformly and simultaneously between the workpiece 105 and all the ten wires 103 is calculated. If all wires 103 are in the electrical discharge state and Iwn=3 A is flowing in the ten wires 103, the machining current of 10×3 A=30 A is necessary as a whole between the machining power supply unit 501 and the power supplying point. Assuming that the voltage drop between the machining power supply unit 501 and the power supplying point is one hundredth of Vmn (0.6 V), the resistance value Rmn in this case is derived as follows. Note that, the voltage drop from the machining power supply unit 501 to the batch power supply terminal 104 only needs to be smaller than 1 V, and smaller than the voltage drop from the batch power supply terminal to the electrical discharge portion. Here, Rmn is 0.6 V/30 A=0.02Ω (resistance value Rmn is a resistance value between the machining power supply unit 501 and the batch power supply terminal 104).

Therefore, the resistance value between the machining power supply unit 501 and the power supply terminal 104 only needs to be smaller than 0.1Ω, and smaller than the resistance value between the batch power supply terminal and the electrical discharge portion. In addition, a ratio of the voltage drop from the machining power supply unit 501 to the batch power supply terminal 104 to the voltage drop from the batch power supply terminal 104 to the electrical discharge portion only needs to be 10 or larger. Further, a ratio of the resistance value from the machining power supply unit 501 to the batch power supply terminal 104 to the resistance value from the batch power supply terminal to the electrical discharge portion only needs to be 10 or larger.

Further, considering Rmn, the machining current of the ten wires is determined as (60 V−30 V)/((10 Ω/10)+0.02Ω)=29.41 A, and the machining current of one wire is 2.941 A.

In addition, even if a current flows in one wire when the electrical discharge state does not occur uniformly and simultaneously between the workpiece 105 and all the ten wires 103, the machining current of one wire becomes (60 V−30 V)/(10 Ω+0.02Ω)=2.994 A, which is not so different from the case where the electrical discharge state occurs uniformly and simultaneously between the workpiece 105 and all the ten wires 103.

In addition, as another effect, when the power is supplied to a plurality of (N) wires 103 (winding around the main rollers 8 and 9 N turns) at one portion (in a batch) in the related-art method, the machining speed becomes 1/N of the machining speed in the case where the power is individually supplied to the wires. However, according to the present invention, even in the case where the power is supplied to N wires 103 at one portion (in a batch), it is possible to maintain the same machining speed as that of the case where the power is individually supplied to the wires 103.

<Holding Apparatus 800 of First Embodiment>

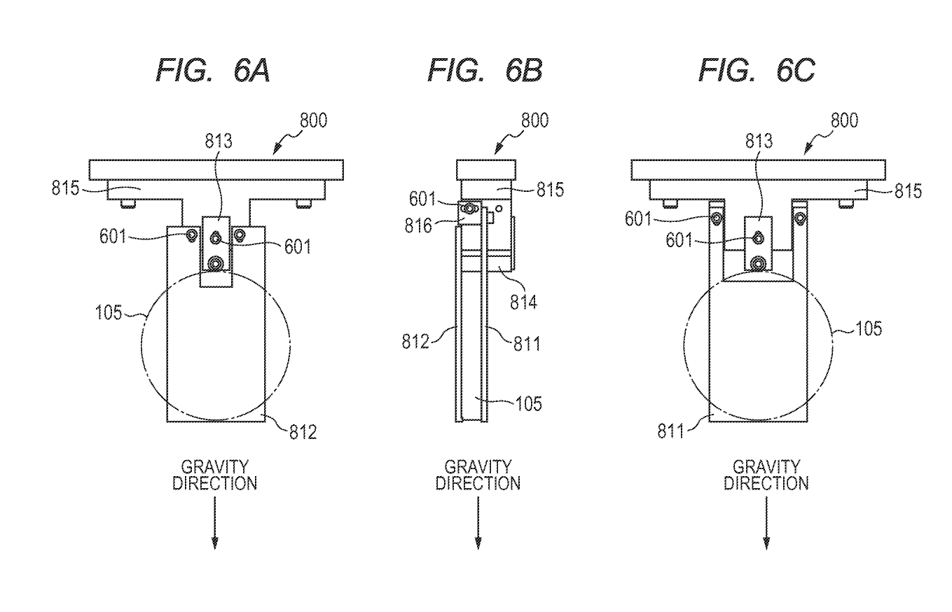

FIGS. 6A to 6C, FIG. 10A to FIG. 12G, and FIG. 15A to FIG. 16D illustrate a holding apparatus 800 according to a first embodiment of the present invention. The holding apparatus 800 of the first embodiment is a holding apparatus which can hold a frustum-shaped ingot.

FIGS. 6A to 6C are referred to for description. FIGS. 6A to 6C illustrate a layout of various components of the holding apparatus (retaining unit) 800 according to the present invention. FIG. 6A is a front view of the holding apparatus 800, FIG. 6B is a side view of the holding apparatus 800, and FIG. 6C is a rear view of the holding apparatus 800. In the following, functions of the various components are described.

The holding apparatus 800 is used in the wire electrical discharge machining apparatus 1 for slicing the ingot (workpiece) 105, and is a holding apparatus for holding the ingot 105 so that the ingot 105 does not fall vertically.

In the example illustrated in FIGS. 6A to 6C, the ingot 105 is cylindrical. In the holding apparatus 800, the ingot 105 is held through contact of holding units 811 and 812 with circular (flat) non-machining surfaces of the ingot 105, and electrical continuity is provided through contact of an ingot retaining roller 814 (energization unit) with a machining surface of the cylindrical ingot 105 (circumferential surface which is a curved surface), which is sliced by the wire 103.

In addition, the holding apparatus 800 is a holding apparatus used in the apparatus 1 for slicing the substantially cylindrical ingot 105 (including a case where the cylindrical ingot includes an orientation flat surface) by electrical discharge machining in a direction opposed to the circumferential surface of the cylindrical ingot 105. In other words, the holding apparatus 800 is a holding apparatus used in the apparatus 1 for slicing the ingot 105 by electrical discharge machining in a direction substantially perpendicular to a certain surface of the ingot 105.

The various components included in the holding apparatus 800 are described in the following.

A side stay A 811 (holding unit) is a holding unit for holding the ingot 105 so that the ingot 105 does not fall vertically by being in intimate contact with the ingot 105 at a place (one circular surface of the ingot 105) different from a place at which the ingot retaining roller 814 is in contact with the ingot 105. The side stay A 811 holds the ingot 105 so that the ingot 105 does not fall vertically by being in contact with the non-machining surface which is not sliced of the ingot 105.

A side stay B 812 (holding unit) also holds the ingot 105 so that the ingot 105 does not fall vertically by being in contact with the non-machining surface which is not sliced of the ingot 105.

The side stay A 811 and the side stay B 812 (holding units) function to hold the ingot 105 so that the ingot 105 does not fall vertically by being in contact with circular surfaces, respectively, of the ingot 105. In other words, each of the side stay A 811 and the side stay B 812 (holding units) functions to hold the ingot 105 so that the ingot 105 does not fall vertically by being in contact with any one surface of the ingot 105 which is different from a surface of the ingot 105 in contact with the ingot retaining roller 814.

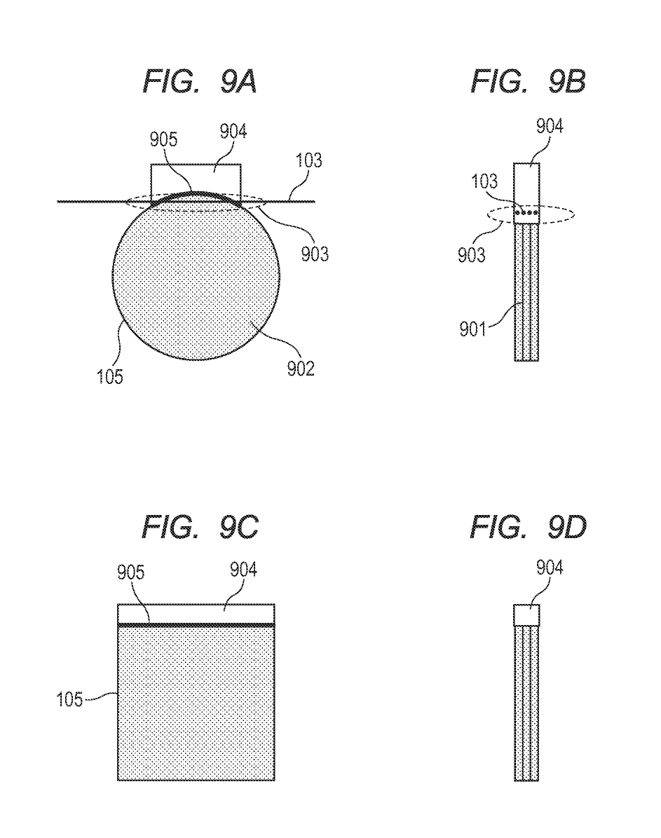

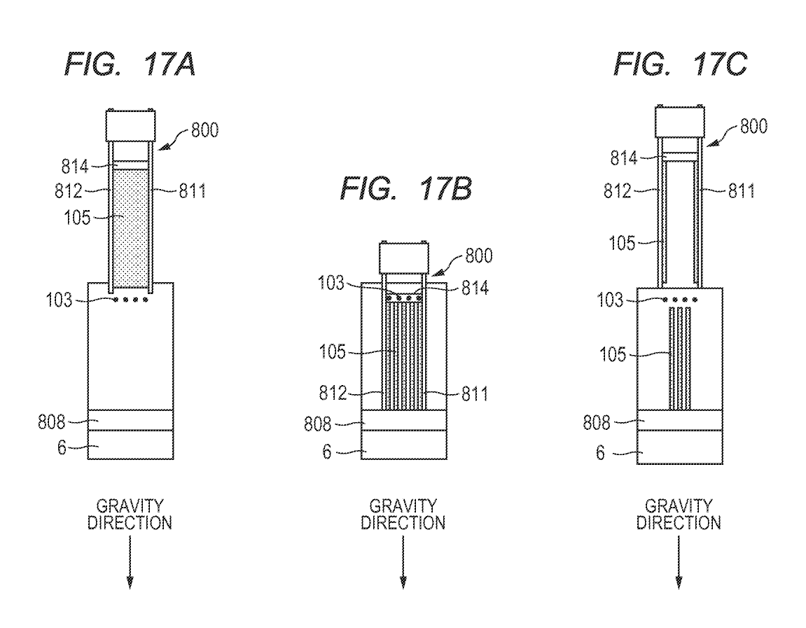

The holding apparatus 800 includes a plurality of (two) holding units 811 and 812. The plurality of holding units 811 and 812 are in contact with the ingot 105 at the circular surfaces (surface 902 illustrated in FIG. 9A), respectively, of the ingot 105. As illustrated in FIGS. 17A to 17C, the holding units 811 and 812 are not on a route which is brought into contact with the wire 103 when the ingot 105 is machined, and hence, are in intimate contact with the ingot 105 at locations (positions) which are not subjected to electrical discharge machining by the wire 103 to hold the ingot 105 so that the ingot 105 does not fall vertically. Note that, the holding units 811 and 812 are mounted to a base 815 of the holding apparatus 800 with a fixing member such as screws 601.

A role of the ingot retaining roller 814 (energization unit) is only to stably pass current through the ingot 105, and the ingot retaining roller 814 itself cannot solely hold the ingot so that the ingot does not fall vertically. Therefore, it is necessary to hold the ingot 105 so that the ingot 105 does not fall vertically at a part other than the ingot retaining roller 814. The ingot retaining roller 814 has a surface shape so as not to be in surface contact with the machining surface of the ingot 105 to be sliced (here, circumferential surface of the cylinder) in the running direction of the wire 103, and the surface is brought into contact with the machining surface to pass machining current for electrical discharge machining through the machining surface. The ingot retaining roller 814 has, for example, a surface shape so as to be in line contact with the circumferential surface of the cylindrical ingot 105. When the ingot 105 is subjected to electrical discharge machining, the ingot retaining roller 814 is at a place at which the ingot retaining roller 814 is sliced after the machining surface of the ingot 105 is sliced. Note that, the ingot retaining roller 814 is mounted to the base 815 with a fixing member such as the screw 601 via retaining roller support plates 813.

If the holding units 811 and 812 do not hold the ingot 105 so that the ingot 105 does not fall vertically, the ingot retaining roller 814 cannot hold the ingot 105. A role of the holding units 811 and 812 is only to hold the ingot 105 so that the ingot 105 does not fall vertically until slicing of the ingot 105 completely ends.

In order to hold the ingot 105 so that the ingot 105 does not fall vertically until slicing of the ingot 105 completely ends, it is necessary that, as illustrated in FIGS. 17A to 17C, the ingot 105 is held at a location (position) other than the route on which the ingot 105 moves toward the wire 103 (in a direction of the slice surface) when the ingot 105 is subjected to electrical discharge machining by the wire 103. The reason is that, a plurality of wires 103 in parallel run on the route on which the ingot 105 moves (in the direction of the slice surface), and thus, if the ingot 105 is not held at a location (position) other than on the route on which the ingot 105 moves (in the direction of the slice surface), the holding units 811 and 812 interfere with the running wire 103.

Therefore, by holding the ingot 105 with the holding unit 811 at the circular surface of the cylindrical ingot 105 (surface 902 illustrated in FIG. 9A), the holding unit 811 is prevented from interfering with the running wire 103 as illustrated in FIGS. 17A to 17C. In addition, by holding the ingot 105 with the holding unit 812 from the side opposite to the circular surface of the cylindrical ingot 105 (surface 902 illustrated in FIG. 9A), that is, by holding the ingot 105 from both sides at the same time, even the heavy cylindrical ingot 105 can be stably held and does not fall vertically.

<First Example of Holding Units 811 and 812>

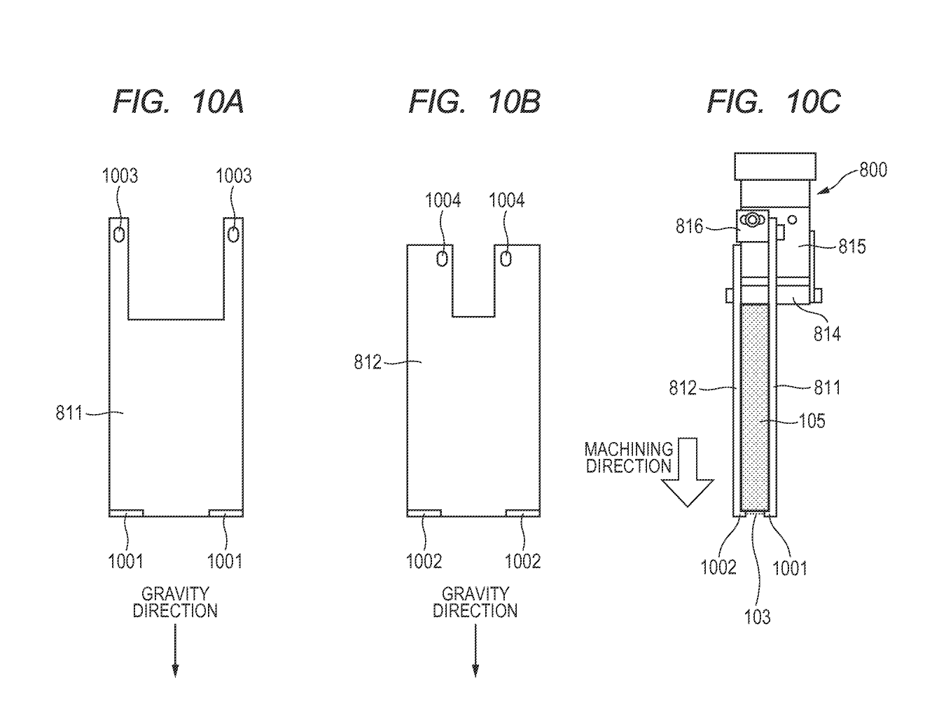

FIGS. 10A to 10C illustrate the holding units 811 and 812 having claws 1001 and 1002, respectively. In order to prevent the heavy cylindrical ingot 105 from falling using the holding unit 811 and the holding unit 812, as illustrated in FIGS. 10A to 10C, the heavy cylindrical ingot 105 may be sandwiched between the holding unit 811 and the holding unit 812 and the sandwiched ingot 105 may be caught at both ends between the claws 1001 and 1002 provided at ends of the holding unit 811 and the holding unit 812, respectively, in a falling direction of the ingot 105 (downward in the vertical direction). As illustrated in FIG. 10C, the claws 1001 and 1002 hold the ingot 105 at locations (positions) other than the route on which the ingot 105 moves toward the wire 103 (in the direction of the sliced surface), and hence, the holding units 811 and 812 are prevented from interfering with the running wire 103. The holding units 811 and 812 may be formed of a material such as aluminum. In addition, by putting aluminum foil or the like between the ingot 105 and the holding units 811 and 812, respectively, stability in conductivity may be enhanced.

The holding units 811 and 812 which are in contact with the non-machining surfaces that are not sliced of the ingot 105 and include the claws 1001 and 1002 in contact with the machining surface of the ingot 105. Therefore, the ingot 105 to be machined may be held by the claws 1001 and 1002 and may be prevented from falling vertically.

In addition, in this case, the ingot 105 nestles between the claws 1001 and 1002 on both sides so as not to fall vertically, and hence, the ingot 105 does not fall vertically even without using a nonconductive adhesive on contact surfaces of the holding unit 811 and the holding unit 812 which are in contact with the ingot 105 from both sides. However, the ingot 105 is required to be caught between the claws 1001 and 1002, and hence, there may be a case where protruding portions of the claws 1001 and 1002 become obstacles on the route on which the ingot 105 moves (in the direction of the sliced surface) at the beginning of the machining to partially generate regions on both sides of the ingot 105 where the ingot 105 cannot be sliced.

In this example, the claws 1001 and 1002 enable the holding apparatus 800 to hold the ingot 105 so that the ingot 105 does not fall without using an adhesive for fixing the ingot 105 to the holding apparatus 800 on any border surface in contact with the ingot. Note that, in this example, the claws 1001 and 1002 are included in the holding units 811 and 812, respectively, but, even if such a claw is included in only one of the holding units 811 and 812, a similar function may be formed.

<Second Example of Holding Units 811 and 812>

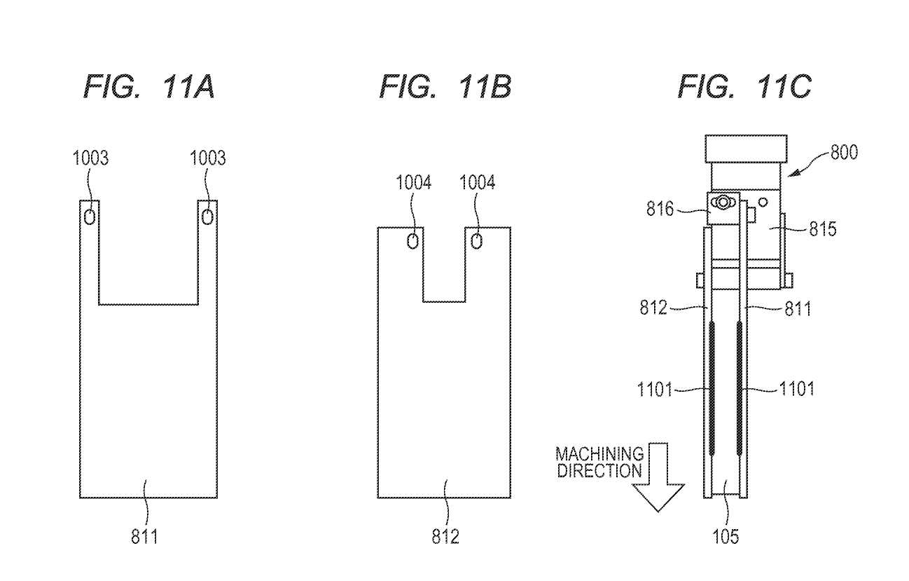

FIGS. 11A to 11C illustrate the holding units 811 and 812 without claws. In order to prevent the heavy cylindrical ingot 105 from falling using the holding unit 811 and the holding unit 812, as illustrated in FIGS. 11A to 11C, the heavy cylindrical ingot 105 may be sandwiched between the holding unit 811 and the holding unit 812 and a nonconductive adhesive 1101 may be used on the contact surfaces of the holding unit 811 and the holding unit 812 with the ingot 105 to bond the cylindrical ingot 105 to the holding unit 811 and the holding unit 812. As illustrated in FIGS. 17A to 17C, the holding units 811 and 812 are bonded to the ingot 105 at locations (positions) other than the route on which the ingot 105 moves (in the direction of the sliced surface), and hence, the holding units 811 and 812 are prevented from interfering with the running wire 103.

By applying the bonding member (nonconductive adhesive) 1101 on the border surfaces of the holding units 811 and 812 in contact with the non-machining surfaces to bond the holding units 811 and 812 to the non-machining surfaces, the ingot 105 is held so as not to fall vertically. In addition, in this case, the ingot can nestle between both sides by the holding power of the nonconductive adhesive 1101 so as not to fall vertically, and the ingot 105 is not required to be caught between the claws unlike the first example. Therefore, there is no obstacle on the route (in the direction of the sliced surface) at the beginning of the machining, and there is no region where the ingot 105 cannot be sliced on both sides thereof. Note that, in this example, the adhesive 1101 is used on both the holding unit 811 and the holding unit 812, but, even if the adhesive 1101 is used on only one of the holding units 811 and 812, a similar function may be formed.

The holding units 811 and 812 may be formed of a material such as aluminum, but a main purpose of the holding units 811 and 812 is to hold the ingot 105, and hence, the holding units 811 and 812 may be formed of a material other than a conductive one such as glass, a semiconductor, a plastic, or rubber. Note that, as a material of the holding units 811 and 812, aluminum which is a conductive material may also be used. In this case, by forming at least a part of the holding units 811 and 812 of a conductive material for the purpose of passing current through the ingot 105 and by bonding the holding units 811 and 812 to the circular surfaces of the ingot 105 (surface 902 illustrated in FIG. 9A) using a conductive adhesive, the holding units 811 and 812 may have an energization function in addition to the holding function.

The side stay B (holding unit) 812 is a holding unit for holding the ingot 105 so that the ingot 105 does not fall vertically by being in intimate contact with the ingot 105 at a place (another circular surface of the ingot 105) different from a place at which the ingot retaining roller 814 is in contact with the ingot 105.

The wire electrical discharge machining apparatus 1 according to the present invention includes the plurality of holding units 811 and 812. The ingot is held by contact of the plurality of holding units 811 and 812 with the non-machining surfaces at a plurality of places, respectively.

As illustrated in FIGS. 17A to 17C, the holding unit 812 is not on the route on which the holding unit 812 interferes with the wire 103 when the ingot 105 is machined, and hence, the holding unit 812 holds the ingot 105 so that the ingot 105 does not fall vertically by being in intimate contact with the ingot 105 at a location (position) at which the holding unit 812 is not subjected to electrical discharge machining by the wire 103. The holding unit 812 functions to hold the ingot 105 so that the ingot 105 does not fall vertically by being in contact with the circular surface of the ingot 105. The holding unit 812 functions to hold the ingot 105 so that the ingot 105 does not fall vertically by being in contact with any one surface of the ingot 105 which is different from the surface of the ingot 105 in contact with the ingot retaining roller 814.

The ingot retaining roller (energization unit) 814 is a conductive ingot retaining roller which is in contact with the circumferential surface of the cylindrical ingot 105 in a shape not conforming to the curved shape of the circumferential surface of the cylindrical ingot 105 and which passes current through the ingot 105 by the contact. The ingot retaining roller 814 is mounted to the base 815 via the retaining roller support plates 813. In other words, the energization unit 814 (ingot retaining roller) functions to pass current through the ingot 105 by being in contact with the circumferential surface of the cylindrical ingot 105 in a surface shape not conforming to the shape of the circumferential surface of the cylindrical ingot 105. The energization unit 814 (ingot retaining roller) functions to pass current through the ingot by being in contact with any one surface of the ingot in a surface shape not conforming to the surface shape of the ingot 105.

The ingot retaining roller 814 is on the route on which the ingot retaining roller 814 interferes with the wire 103 as the machining of the ingot 105 proceeds as illustrated in FIGS. 17A to 17C. Therefore, the ingot retaining roller 814 is in contact with the ingot 105 at a location (position) at which the ingot retaining roller 814 is subjected to electrical discharge machining by the wire 103 to pass current through the ingot 105.

A role of the ingot retaining roller 814 is to maintain current passing through the ingot 105 until slicing of the ingot 105 completely ends. In other words, the ingot retaining roller 814 is required to be in direct contact with the circumferential surface of the cylindrical ingot 105 (surface 901 illustrated in FIG. 9B) without fail. When contact is achieved with a shape that conforms to the shape of the contact surface of the ingot 105 (surface 901 illustrated in FIG. 9B) as the shape of a beam 904 illustrated in FIGS. 9A and 9C, current passing through the ingot 105 can be maintained with a large area. But, when the cylindrical ingot 105 is managed to be completely sliced, there is a region in which both the beam 904 and the ingot 105 are subjected to electrical discharge machining (region 903 surrounded by a broken line illustrated in FIGS. 9A and 9B) at a stage immediately before the electrical discharge machining ends. In this region in which both the beam 904 and the ingot 105 are subjected to electrical discharge machining, the region in which the beam 904 (formed of, for example, Al) and the ingot 105 (formed of, for example, SiC) of different materials exist in a mixed manner is required to be simultaneously subjected to electrical discharge machining with the one wire 103. Therefore, the electrical discharge phenomenon caused by the one wire 103 locally differs in the region in which the beam 904 and the ingot 105 exist in a mixed manner, which causes the electrical discharge phenomenon to be unstable and causes the wire 103 to easily break.

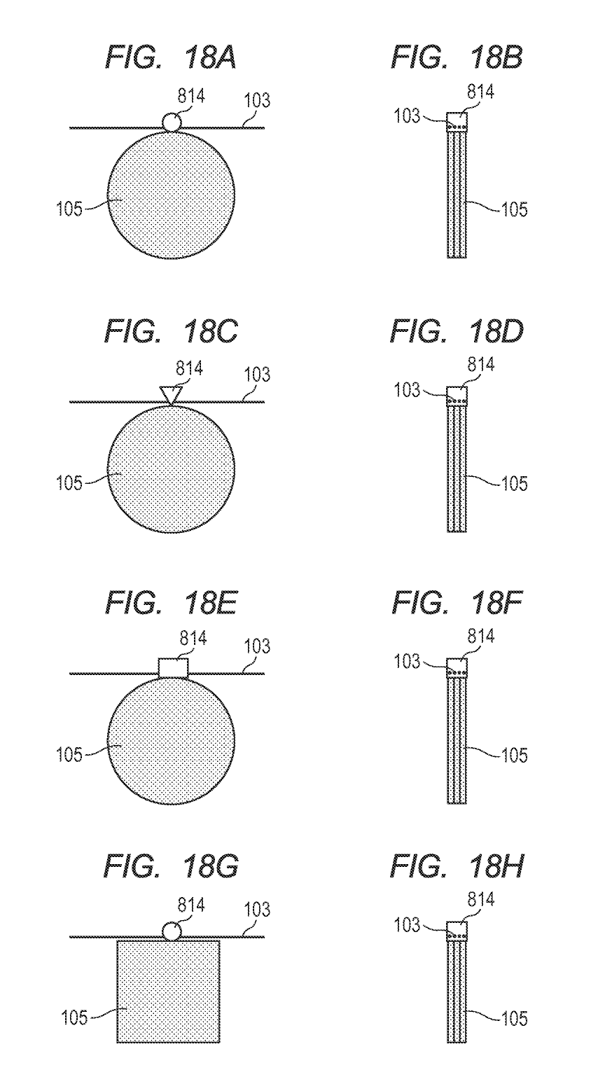

In order to eliminate a region in which both the beam 904 and the ingot 105 are to be subjected to electrical discharge machining such as the region 903 surrounded by the broken line in FIGS. 9A and 9B, the area of the energization unit 814 (ingot retaining roller) in contact with the cylindrical ingot 105 may be reduced as small as possible while the electrical continuity can be provided with stability. In other words, the surface of the ingot 105 through which current is passed (surface 901 illustrated in FIG. 9B) and the surface of the energization unit 814 in a shape conforming to that surface are not in contact with each other in a large area. In this case, only a contact surface portion of the energization unit 814 is machined so as to be in a shape not conforming to the surface of the ingot 105 through which current is passed (surface 901 illustrated in FIG. 9B) as an appropriate shape to be in contact with the cylindrical ingot 105. Therefore, the energization unit 814 and the ingot 105 only need to be in contact with each other in a small area under a state in which the contact surface of the energization unit 814 is in the shape not conforming to the surface of the ingot 105, such as shapes illustrated in FIGS. 18A to 18H. The shape of the contact surface of the energization unit 814 may be a shape which does not conform to the machining surface of the ingot 105 in a direction in parallel to a running direction of the wire 103. For example, the shape of the contact surface of the energization unit 814 may be a shape in line contact with the machining surface of the ingot 105 in a direction which is perpendicular to the running direction of the wire 103, for example, a direction in which the wires are arranged in parallel. Therefore, the shape of the contact surface of the energization unit 814 is not limited to a roller shape, and may be, for example, semicylindrical or polygonal cylindrical, in accordance with the shape of the surface of the ingot 105.

By causing the ingot retaining roller 814 and the ingot 105 to be in contact with each other in a small area by the shape of the energization unit 814 illustrated in FIGS. 18A to 18H in this way, the contact area can be reduced to be as small as possible while the electrical continuity can be provided with stability. However, the area of the contact surface of the ingot retaining roller 814 with the ingot 105 is smaller than that of the beam illustrated in FIGS. 9A to 9D, and hence, even if a conductive adhesive is used, the ingot cannot be held so as not to fall vertically. Here, a role of the energization unit 814 is only to provide electrical continuity with stability, and is not to hold the ingot 105 so that the ingot 105 does not fall vertically, and hence, no conductive adhesive is required to be used between the contact surfaces of the energization unit 814 and the ingot 105.

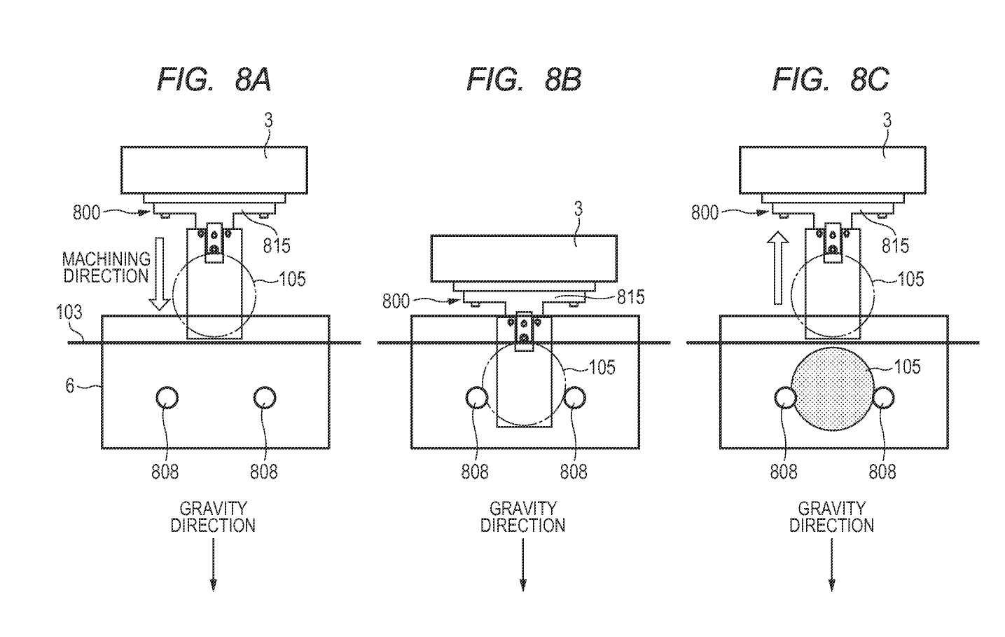

In this way, the energization unit 814 itself cannot solely hold the ingot 105 so that the ingot 105 does not fall vertically, and hence, as illustrated in FIG. 8C and FIG. 17C, when the slicing of the ingot 105 completely ends, the slices of the ingot 105 (wafers) cannot be held. Therefore, the slices of the ingot 105 (wafers) fall vertically.

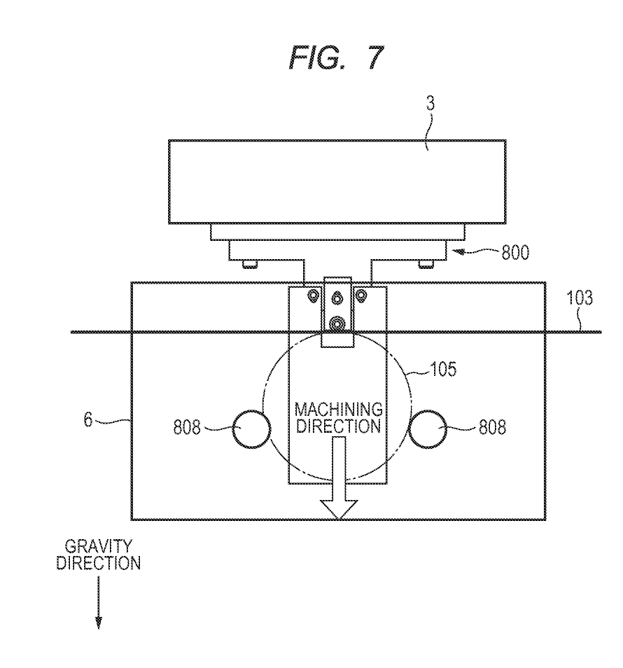

FIG. 7 is referred to for description. FIG. 7 is a front view illustrating relative positional relationship between the holding apparatus (retaining unit) 800 and the multi-wire electrical discharge machining apparatus 1, and corresponds to a state at the end of the machining illustrated in FIG. 8B.

Sliced wafer retainers 808 can retain the sliced wafers in the machining vessel 6.

FIGS. 8A to 8C are referred to for description. FIGS. 8A to 8C are front views illustrating change in relative position in machining between the holding apparatus (retaining unit) 800 and the multi-wire electrical discharge machining apparatus 1. FIG. 8A illustrates the machining vessel 6 and the holding apparatus 800 with the ingot 105 at the beginning of the machining. FIG. 8B illustrates the machining vessel 6 and the holding apparatus 800 at the end of the machining. FIG. 8C illustrates the machining vessel 6 and the holding apparatus 800 when, after the ingot 105 is machined, the holding apparatus (Z stage) 800 is pulled up from the machining vessel 6.

At the beginning of the machining, as illustrated in FIG. 8A, the holding apparatus 800 for holding the ingot 105 moves toward the wire 103 in a machining direction shown by an arrow in the figure based on operation of the workpiece feeding unit 3. At this time, the ingot 105 is subjected to electrical discharge machining by the wire 103, and the machining ends at a position illustrated in FIG. 8B. After that, when the holding apparatus 800 is pulled up to the position at the beginning of the machining based on the operation of the workpiece feeding unit 3 as illustrated in FIG. 8C, both ends of the ingot 105 which has been subjected to electrical discharge machining by the wire 103 are held by the holding units 811 and 812 and are pulled up. The other portions of the ingot 105 (slices) are held by the wafer retainers 808 in the machining vessel 6 to be left in the machining vessel 6.

FIGS. 9A to 9D are referred to for description. FIGS. 9A to 9D illustrate a related-art method of holding the ingot. FIG. 9A is a front view when the cylindrical ingot 105 is held by the beam 904. FIG. 9B is a side view when the cylindrical ingot 105 is held by the beam 904. FIG. 9C is a front view when a rectangular prismatic ingot 105 is held by the beam 904. FIG. 9D is a side view when the rectangular prismatic ingot 105 is held by the beam 904.

In the related art, as illustrated in FIGS. 9A to 9D, the machining surface (surface sliced by the wire 103) of the ingot 105 and the beam 904 are brought into surface contact with each other, and, by using an adhesive 905 (conductive adhesive) at a border surface therebetween, electrical continuity between the ingot 105 and the beam 904 is maintained, and in addition, the ingot 105 is held so as not to fall off the beam 904. At this time, when, as illustrated in FIGS. 9C and 9D, the ingot 105 is rectangular prismatic having a flat machining surface, the region in which the electrical discharge machining proceeds includes no region where the beam 904 and the ingot 105 of different materials exist in a mixed manner as the electrical discharge machining proceeds. However, when, as illustrated in FIGS. 9A and 9B, the ingot 105 is cylindrical and has a curved machining surface, the region in which the electrical discharge machining proceeds includes a region 903 surrounded by the broken line where the beam 904 and the ingot 105 of different materials exist in a mixed manner as the electrical discharge machining proceeds.

FIGS. 10A to 10C are referred to for description. FIGS. 10A to 10C illustrate shapes and a layout of the holding units 811 and 812 (side stays with the claws 1001 and 1002) included in the holding apparatus 800. FIG. 10A illustrates the holding unit 811 having the claws 1001. FIG. 10B illustrates the holding unit 812 having the claws 1002. FIG. 10C is a side view of the holding apparatus 800 including the holding units 811 and 812 which have the claws 1001 and 1002. FIGS. 10A to 10C illustrate the first example of the holding units 811 and 812.

With reference to FIG. 10A, the holding unit 811 includes the claws 1001 which can hold the ingot 105 so that the ingot 105 does not fall vertically at locations at which the claws 1001 are not subjected to electrical discharge machining when the ingot 105 is sliced in a direction (machining direction) toward the circumferential surface of the cylinder (surface 901 illustrated in FIG. 9B). In addition, the holding unit 811 has screw holes 1003 (at two places) provided therein for mounting the holding unit 811 to a support block 816 with the screws 601.

With reference to FIG. 10B, the holding unit 812 also includes the claws 1002 which can hold the ingot 105 so that the ingot 105 does not fall vertically at locations at which the claws 1002 are not subjected to electrical discharge machining when the ingot 105 is sliced in the direction (machining direction) toward the circumferential surface of the cylinder (surface 901 illustrated in FIG. 9B). In addition, the holding unit 812 also has screw holes 1004 (at two places) provided therein for mounting the holding unit 812 to the base 815 with the screws 601.

FIGS. 11A to 11C are referred to for description. FIGS. 11A to 11C illustrate shapes of the holding units 811 and 812 (side stays without claws) included in the holding apparatus 800. FIG. 11A illustrates the holding unit 811 without claws. FIG. 11B illustrates the holding unit 812 without claws. FIG. 11C is a side view of the holding apparatus including the holding units 811 and 812 without claws. FIGS. 11A to 11C illustrate the second example of the holding units 811 and 812.

The holding unit 811 without claws which is illustrated in FIG. 11A holds the ingot 105 by applying the nonconductive adhesive 1101 to the border surface thereof in contact with the circular surface of the ingot 105 (surface 902 illustrated in FIG. 9A) to bond the holding unit 811 to the circular surface, as illustrated in FIG. 11C.

The holding unit 812 without claws which is illustrated in FIG. 11B also holds the ingot 105 by applying the nonconductive adhesive 1101 to the border surface thereof in contact with the circular surface of the ingot 105 (surface 902 illustrated in FIG. 9A) to bond the holding unit 812 to the circular surface opposite to the surface to which the holding unit 811 is bonded, as illustrated in FIG. 11C.

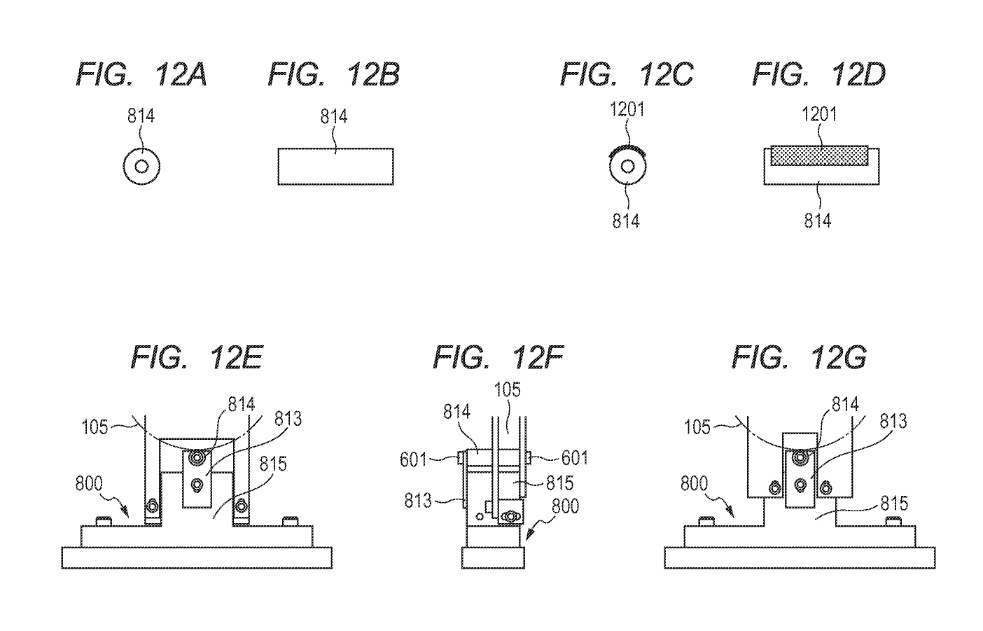

FIGS. 12A to 12G are referred to for description. FIGS. 12A to 12G illustrate a shape and a layout of a component (ingot retaining roller 814) included in the holding apparatus 800. FIGS. 12A and 12B are a front view and a side view, respectively, of the ingot retaining roller 814. FIGS. 12C and 12D are a front view and a side view, respectively, of a modification of the ingot retaining roller 814. FIG. 12E is a rear view of the holding apparatus 800 including the ingot retaining roller 814, FIG. 12F is a side view of the holding apparatus 800, and FIG. 12G is a front view of the holding apparatus 800. In this case, the ingot retaining roller 814 is formed of a material such as aluminum or stainless steel (SUS).

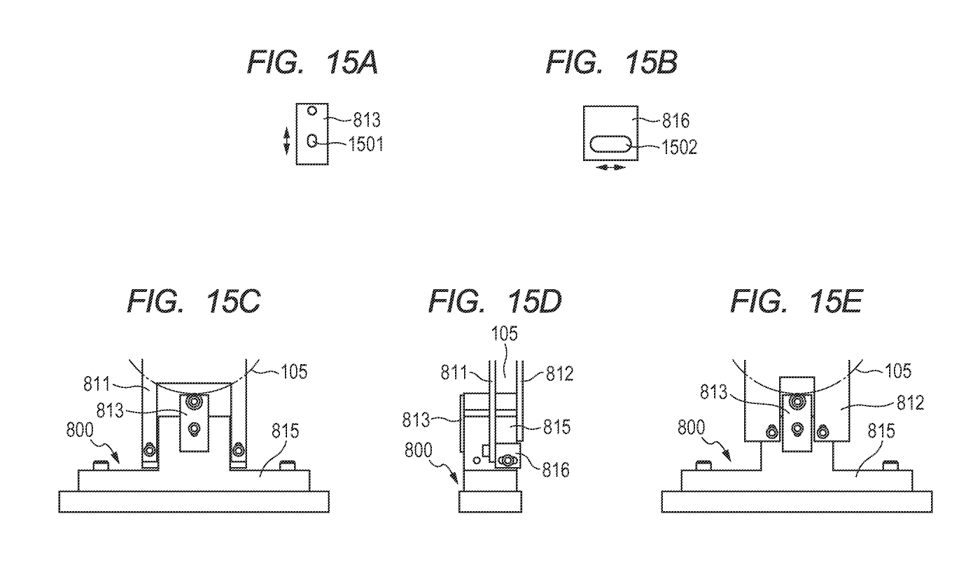

Both sides of the ingot retaining roller 814 illustrated in FIGS. 12A and 12B are mounted to the retainer roller support plates 813 with the screw 601 as illustrated in FIGS. 12E to 12G. As illustrated in FIG. 15A, the ingot retaining roller 814 can accommodate an arbitrary size of an ingot diameter (workpiece diameter) by forming screw holes in the retainer roller support plates 813 as elongated holes. In addition, by providing a conductive aluminum double-faced tape 1201 onto a circumferential surface of the cylindrical ingot retaining roller 814 as illustrated in FIGS. 12C and 12D, a gap between the ingot 105 and the ingot retaining roller 814 can be filled as described below. This enables uniform machining of the ingot 105. Similarly, depending on the state of the gap between the ingot 105 and the ingot retaining roller 814, not the conductive aluminum tape but a conductive silicon bond may fill the gap in the machining.

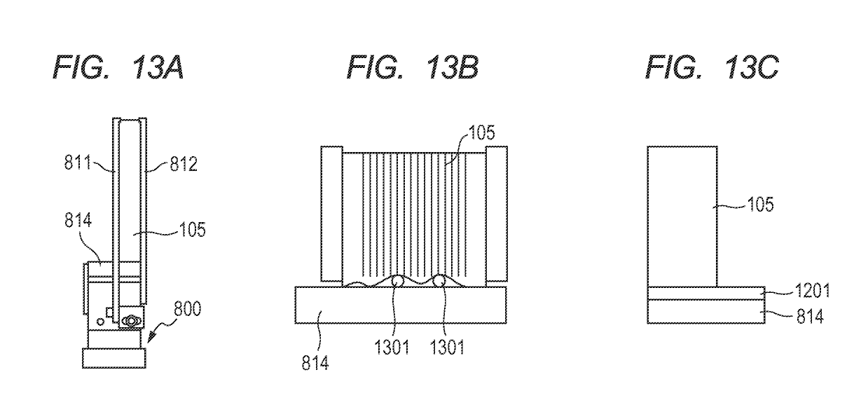

FIGS. 13A to 13C are referred to for description. FIGS. 13A to 13C illustrate a contact state between the ingot retaining roller 814 and the ingot 105. FIG. 13A is a side view of the holding apparatus 800 including the ingot retaining roller 814. FIG. 13B illustrates a case where a gap 1301 exists between the ingot retaining roller 814 and the ingot 105. FIG. 13C illustrates a case where the aluminum double-faced tape 1201 is provided between the ingot retaining roller 814 and the ingot 105.

As illustrated in FIG. 13A, the ingot retaining roller 814 is in contact with the ingot 105 and functions to pass current therethrough. In this case, when the gap 1301 exists between the ingot retaining roller 814 and the ingot 105 as illustrated in FIG. 13B, electricity is not supplied from the ingot retaining roller 814 to the ingot 105 at locations at which the gap 1301 exists, and the machining stops. By providing a conductive tape such as the aluminum double-faced tape 1201 for filling the gap between the ingot retaining roller 814 and the ingot 105 as illustrated in FIG. 13C, electrical continuity between the ingot retaining roller 814 and the ingot 105 can be secured by the conductive tape.

By providing a conductive tape such as the aluminum double-faced tape 1201 for filling the gap between the ingot retaining roller 814 and the ingot 105 in this way, the electrical continuity between the ingot retaining roller 814 and the ingot 105 can be secured. In addition, at the end of the machining, the end of the machining can be detected and confirmed by difference between a machining signal and a signal from the ingot retaining roller 814.

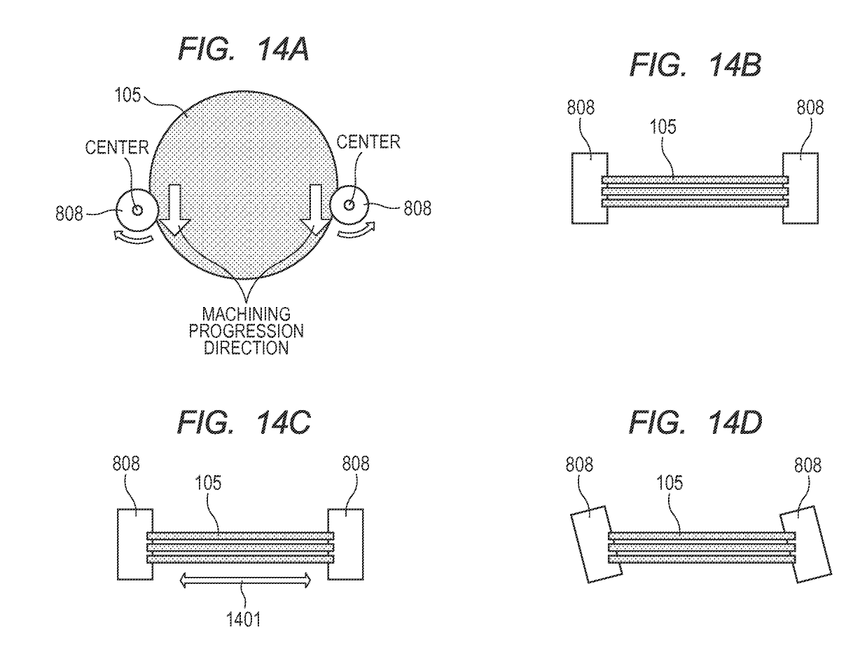

FIGS. 14A to 14D are referred to for description. FIGS. 14A to 14D illustrate a shape of components included in the machining vessel 6 (wafer retainers 808 in the machining vessel). FIG. 14A is a front view illustrating the ingot 105 and the wafer retainers 808 included in the machining vessel 6. FIG. 14B is a top view illustrating the ingot 105 (wafers) and the wafer retainers 808. FIG. 14C is a top view for illustrating a function of the wafer retainers 808 against horizontal vibrations. FIG. 14D is a top view for illustrating a function of the wafer retainers 808 against position displacement.

The wafer retainers 808 in the machining vessel are apparatus for holding the wafers 105 so that the wafers 105 do not fall to pieces into the machining vessel by retaining the ingot 105 cut into slices (wafers) at the end of the machining. The wafer retainers 808 may be formed of a urethane, a spongy resin, or the like. In addition, as illustrated in FIGS. 14A and 14B, the wafer retainers 808 can rotate about center portions thereof, respectively, while retaining the wafers 105 as the ingot 105 is machined.

By forming the wafer retainers 808 of a flexible material such as sponge, the wafer retainers 808 can prevent a chip at an edge of the wafers 105 when the wafers 105 are retained. Similarly, when the wafers 105 horizontally vibrate as shown by an arrow 1401 in FIG. 14C, the wafer retainers 808 absorb the vibrations, and hence, influence on the machining can be inhibited. In addition, even when the positions of the wafer retainers 808 are displaced, a shock absorbing function of the wafer retainers 808 enables retainment of the wafers 105 with a minimum load thereon without influence on the machining as illustrated in FIG. 14D.

In addition, the wafer retainers 808 are formed of a resilient material such as sponge, and hence, it is easy to uniformize retaining force on the wafers 105. In addition, as described above, the wafer retainers 808 rotate in a direction in which the machining of the wafers 105 proceeds, and hence, it is easy to relieve stress caused in a fixed direction. The wafer retainers 808 mounted to the machining vessel 6 are formed of a resilient material such as sponge, and hence, vibrations of the machining vessel 6 due to flow of a machining fluid and the like may be alleviated.

FIGS. 15A to 15E are referred to for description. FIGS. 15A to 15E illustrate shapes of components (retaining roller support plates 813 and support block 816) included in the holding apparatus 800. FIG. 15A illustrates the retaining roller support plate 813. FIG. 15B illustrates the support block 816. FIG. 15C is a rear view of the holding apparatus 800 including the retainer roller support plates 813 and the support block 816. FIG. 15D is a side view of the holding apparatus 800. FIG. 15E is a front view of the holding apparatus 800. In this case, the retaining roller support plates 813 and the support block 816 may be formed of a material such as aluminum or SUS.

As illustrated in FIG. 15A, the retaining roller support plate 813 has an elongated hole (screw hole) 1501 provided therein for enabling a fine-tuning of a distance between another component (such as the ingot retaining roller or the holding unit) included in the holding apparatus 800 and the ingot 105 in accordance with the size of the ingot 105. By changing a screwed position, the distance between another component (such as the ingot retaining roller or the holding unit) and the ingot 105 can be adjusted. In other words, as illustrated in FIG. 15A, the elongated hole 1501 extending in a diameter direction of the ingot 105 when the ingot 105 is held by the holding units 811 and 812 (shown by an arrow in FIG. 15A) is provided in the retaining roller support plate 813. Therefore, as illustrated in FIGS. 15C to 15E, by mounting the ingot retaining roller 814 to the retaining roller support plates 813 via a fixing member such as a screw at an arbitrary position in the elongated hole 1501, the distance between another component (such as the ingot retaining roller or the holding unit) included in the holding apparatus 800 and the ingot 105 can be fine-tuned.

The holding unit 811 is mounted to the support block 816. The support block 816 supports the holding unit 811 and is mounted to the base 815. An elongated hole 1502 corresponding to a thickness direction of the ingot 105 (shown by an arrow in FIG. 15B) is provided in the support block 816. As illustrated in FIG. 15D, the holding unit 811 is mounted to the support block 816 via a fixing member such as the screw 601 at an arbitrary position in the elongated hole 1502. This enables adjustment of the position at which the holding unit 811 is supported in accordance with the thickness of the ingot 105.

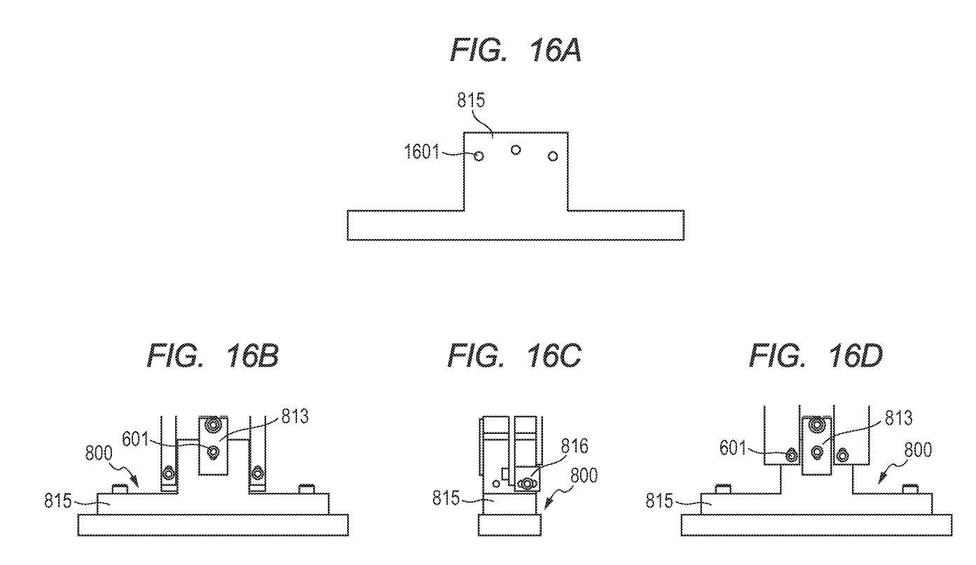

FIGS. 16A to 16D are referred to for description. FIGS. 16A to 16D illustrate a shape of a component (base 815) included in the holding apparatus 800. FIG. 16A illustrates the base 815. FIG. 16B is a rear view of the holding apparatus 800 including the base 815. FIG. 16C is a side view of the holding apparatus 800. FIG. 16D is a front view of the holding apparatus 800. The base 815 may be formed of aluminum, SUS, or the like.

The base 815 has a substantially T-shape as illustrated in FIG. 16A, and has holes (screw holes) 1601 provided therein for being coupled to other components. As illustrated in FIGS. 16B to 16D, the base 815 is coupled to other components included in the holding apparatus 800 (retaining roller support plates 813, support block 816, and the like) via the holes 1601 with fixing members such as the screws 601.

FIGS. 17A to 17C are referred to for description. FIGS. 17A to 17C are side views illustrating change in relative position in machining between the holding apparatus 800 and the multi-wire electrical discharge machining apparatus. FIG. 17A illustrates the relative positions between the holding apparatus 800 and the multi-wire electrical discharge machining apparatus at the beginning of the machining. FIG. 17B illustrates the relative positions between the holding apparatus 800 and the multi-wire electrical discharge machining apparatus at the end of the machining. FIG. 17C illustrates the relative position between the holding apparatus 800 and the multi-wire electrical discharge machining apparatus when the holding apparatus (Z stage) 800 is pulled up after the machining ends.

As illustrated in FIG. 17A, at the beginning of the machining, the ingot retaining roller 814 of the holding apparatus 800 is in contact with the ingot 105 to pass current through the ingot 105. In addition, as illustrated in FIG. 17B, the ingot retaining roller 814 passes current through the ingot by being in contact with the circumferential surface (surface 901 illustrated in FIG. 9B) of the cylinder even at a location (position at the end of the machining) at which the ingot retaining roller 814 is subjected electrical discharge machining after the ingot 105 is cut into slices in the direction (machining direction) toward the circumferential surface of the cylinder. Specifically, the electrical continuity with the ingot 105 can be maintained by the contact with the ingot 105 at this position until the slicing by the electrical discharge ends. Therefore, the ingot retaining roller 814 is partly cut after the ingot 105 is completely cut into slices of wafers.

In addition, the ingot retaining roller 814 is in contact with the circumferential surface of the cylinder without a conductive adhesive applied to the border surface thereof with the circumferential surface of the cylinder (surface 901 illustrated in FIG. 9B), and hence, cannot hold the ingot (wafers) after being cut into slices. When the holding apparatus 800 (Z stage) is pulled up, the slices of wafers fall in the gravity direction as illustrated in FIG. 17C.

As illustrated in FIG. 17B, the holding unit 811 and the holding unit 812 hold the ingot 105 by being in contact with the circular surfaces (surface 902 in FIG. 9A) at locations at which the holding units 811 and 812 are not subjected to electrical discharge machining when the ingot 105 is sliced in the direction toward the circumferential surface of the cylinder. In other words, the holding units 811 and 812 can continue to hold the ingot 105 at positions at which the holding units 811 and 812 do not interfere with the running wires 103 during the electrical discharge machining while the ingot 105 is driven upward and downward by holding the ingot 105 at this position.

<Modification of Energization Unit 814>

FIGS. 18A to 18H are referred to for description. FIGS. 18A to 18H illustrate modifications of a shape of the energization unit 814 in relation to various kinds of machining surface shapes of the ingot 105 (circular cylindrical and rectangular prismatic). FIG. 18A is a front view illustrating a circular (roll-shaped) energization unit 814 in contact with the circular cylindrical ingot 105. FIG. 18B is a side view illustrating the energization unit 814. FIG. 18C is a front view illustrating a triangular (pointed) energization unit 814 in contact with the circular cylindrical ingot. FIG. 18D is a side view illustrating the energization unit 814. FIG. 18E is a front view illustrating a flat energization unit 814 in contact with the circular cylindrical ingot. FIG. 18F is a side view illustrating the energization unit 814. FIG. 18G is a front view illustrating a circular (roll-shaped) energization unit 814 in contact with the rectangular prismatic ingot. FIG. 18H is a side view illustrating the energization unit 814. Note that, the various kinds of shapes of the ingot 105 are not limited to a circular cylinder (column) and a rectangular prism, but may also be, for example, a triangular prism or a polygonal cylinder, and the illustrated modifications of the energization unit 814 may be used therefor.

In the following, description is made of the relationship between the shape of the energization unit 814 and the shape of the ingot 105 which can solve the problem of the present invention.

(No. 1) A case is described in which the electrical continuity is provided between the circular cylindrical ingot 105 and the roll-shaped energization unit 814 illustrated in FIG. 18A.

When the relationship between the energization unit 814 and the machining surface which are in contact with each other to provide electrical continuity is seen from the front, as illustrated in FIG. 18A, the energization unit 814 swells toward the machining surface and the wire 103. Note that, in this case, it is enough that the energization unit 814 swells, and hence, the energization unit 814 is not limited to a roll-shape but may also be a semicylinder or a polygonal cylinder. When the relationship between the energization unit 814 and the machining surface which are in contact with each other to provide the electrical continuity is seen from a side, as illustrated in FIG. 18B, the energization unit is not in surface contact but in line contact with the machining surface.

(No. 2) A case is described in which the electrical continuity is provided between the circular cylindrical ingot 105 and the pointed energization unit 814 illustrated in FIG. 18C.

When the relationship between the energization unit 814 and the machining surface which are in contact with each other to provide electrical continuity is seen from the front, as illustrated in FIG. 18C, the energization unit 814 swells toward the machining surface and the wire 103. When the relationship between the energization unit 814 and the machining surface which are in contact with each other to provide the electrical continuity is seen from a side, as illustrated in FIG. 18D, the energization unit 814 is not in surface contact but in line contact with the machining surface.

(No. 3) A case is described in which the electrical continuity is provided between the circular cylindrical ingot 105 and the flat energization unit 814 illustrated in FIG. 18E.

When the relationship between the energization unit 814 and the machining surface which are in contact with each other to provide electrical continuity is seen from the front, as illustrated in FIG. 18E, the energization unit 814 is formed so as to be flat in parallel with the wire 103. When the relationship between the energization unit 814 and the machining surface which are in contact with each other to provide the electrical continuity is seen from a side, as illustrated in FIG. 18F, the energization unit 814 is not in surface contact but in line contact with the machining surface.

(No. 4) A case is described in which the electrical continuity is provided between the rectangular prismatic ingot 105 and the roll-shaped energization unit 814 illustrated in FIG. 18G.

When the relationship between the energization unit 814 and the machining surface which are in contact with each other to provide electrical continuity is seen from the front, as illustrated in FIG. 18G, the energization unit 814 swells toward the machining surface and the wire 103. Note that, in this case, it is enough that the energization unit 814 swells, and hence, the energization unit 814 is not limited to a roll-shape but may also be a semicylinder which is obtained by dividing the roll-shape in half or a polygonal cylinder. When the relationship between the energization unit 814 and the machining surface which are in contact with each other to provide the electrical continuity is seen from a side, as illustrated in FIG. 18H, the energization unit 814 is not in surface contact but in line contact with the machining surface.

Forming the energization unit 814 so as to be flat in parallel with the wire 103 or so as to swell toward the wire 103 in this way, a contact area between the machining surface and the energization unit 814 can be minimized, and, in the region in which the electrical discharge machining proceeds, the region in which the energization unit 814 and the ingot 105 of different materials exist in a mixed manner as the electrical discharge machining proceeds can be eliminated.

<Holding Apparatus 800 of Second Embodiment>

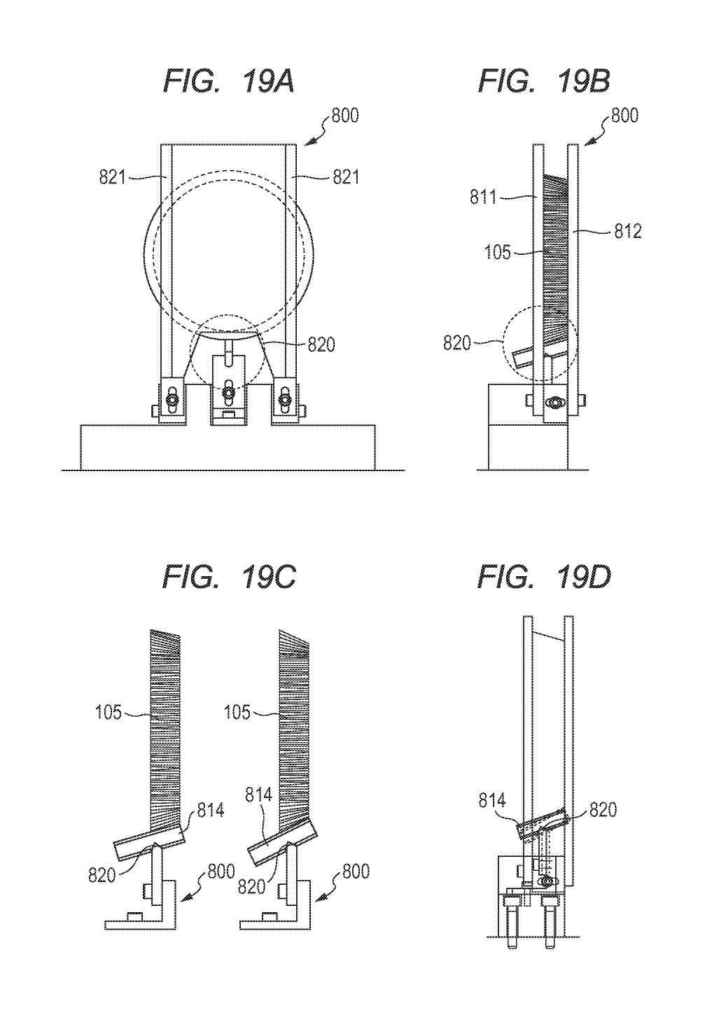

FIGS. 19A to 19D are referred to for description. FIGS. 19A to 19D illustrate a cup-shaped (frustum-shaped) ingot 105 and the holding apparatus 800 according to a second embodiment of the present invention. The holding apparatus 800 includes a mechanism 820 for adjusting an angle of the ingot retaining roller 814 accommodating the cup. FIG. 19A is a front view of the holding apparatus 800. FIG. 19B is a side view of the holding apparatus 800. FIGS. 19C and 19D illustrate operation of the angle adjusting mechanism 820. The holding apparatus 800 of the second embodiment is a holding apparatus which can hold the frustum-shaped ingot 105. In FIG. 19C, for the purpose of illustrating the operation of the angle adjusting mechanism 820, the holding units 811 and 812 are eliminated, and the holding apparatus 800 which accommodates two ingots 105 of different inclination angles is illustrated. In FIG. 19A, slanted portions 821 to be described below are illustrated.

The ingot 105 illustrated in FIGS. 19A to 19D is a frustum-shaped ingot, and the machining surface of the frustum-shaped ingot 105 has a taper angle.

The angle adjusting mechanism (angle adjusting unit) 820 can adjust the angle of the ingot retaining roller 814 as illustrated in FIGS. 19C and 19D. As illustrated in FIGS. 19B and 19C, the angle adjusting mechanism 820 is configured to adjust an angle (contact angle) of the ingot retaining roller 814 in contact with the circumferential machining surface of the ingot 105 which is approximately frustum-shaped so as to correspond to the taper angle of the machining surface of the ingot 105.

In the example illustrated in FIGS. 19A to 19D, the ingot 105 is frustum-shaped. The ingot 105 is held through the contact of the holding units 811 and 812 with circular non-machining surfaces. The electrical continuity is provided through the contact of the ingot retaining roller 814 with the machining surface which is a circumferential surface of the frustum-shaped ingot 105.

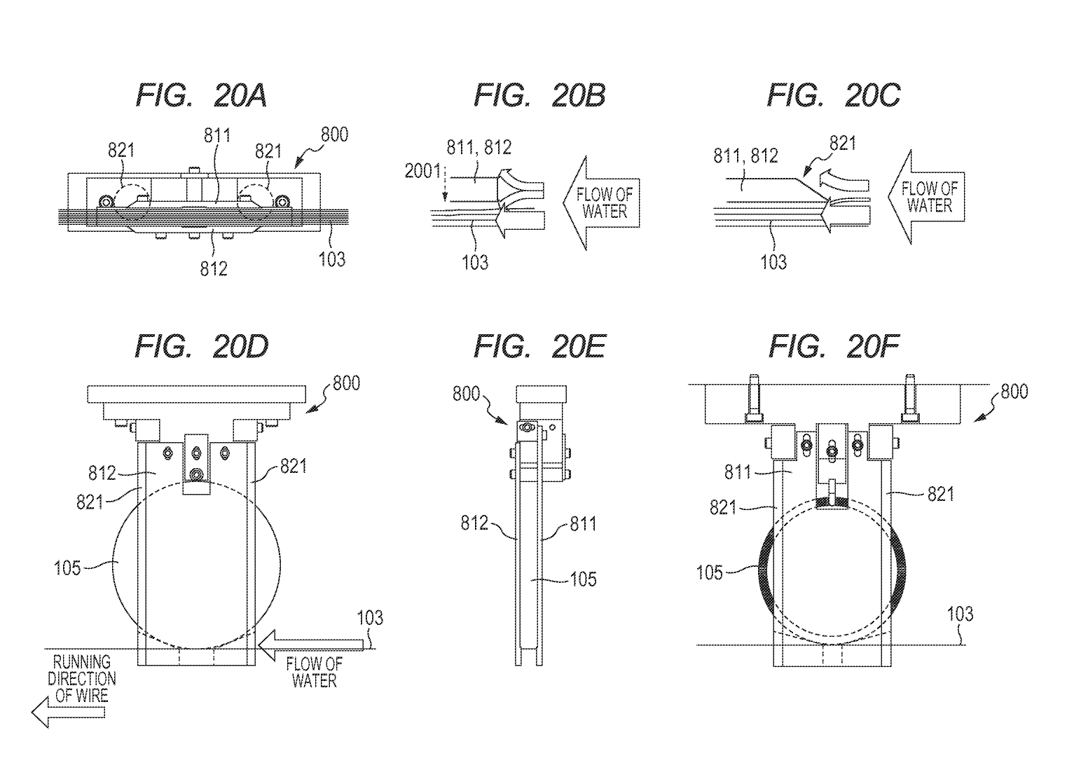

FIGS. 20A to 20F are referred to for description. The holding units 811 and 812 illustrated in FIGS. 20A to 20F include the slanted portions 821 for inhibiting resistance to a water flow. Specifically, the holding units 811 and 812 are slanted in order to control a water flow. FIG. 20A is a bottom view of the holding apparatus 800 including the holding units 811 and 812 with the slanted portions 821 and the wire 103. FIG. 20B illustrates influence of a water flow on the wire 103 when the slanted portions are not provided. FIG. 20C illustrates influence of a water flow on the wire 103 when the slanted portions are provided. FIG. 20D is a front view of the holding apparatus 800 including the holding units 811 and 812 with the slanted portions 821. FIG. 20E is a side view of the holding apparatus 800. FIG. 20F is a rear view of the holding apparatus 800. Note that, the ingot 105 may be a frustum-shaped, circular cylindrical, or rectangular prismatic ingot.

In a case where the slanted portions 821 are not included in the holding units 811 and 812, as illustrated in FIG. 20B, when a water flow strikes the holding units 811 and 812, the water flows around to a side of the holding units 811 and 812 which may influence the straightness of the wire 103 to warp the wire 103 in a transverse direction shown by an arrow 2001 in the figure. The wire 103 may run in a warped state to influence the shape of the ingot 105 which has been sliced.

On the other hand, when the slanted portions 821 are included in the holding units 811 and 812, as illustrated in FIG. 20C, the water is allowed to flow away (escapes) from the wire along the slanted portion 821. Therefore, the influence of the water flow on the straightness of the wire can be reduced to improve the shape of the ingot which has been sliced by the machining.

Note that, the holding units 811 and 812 with the slanted portions 821 are, as illustrated in FIGS. 20D to 20F, included in the holding apparatus 800 in a layout similar to that of the case of the holding units 811 and 812 without the slanted portions.

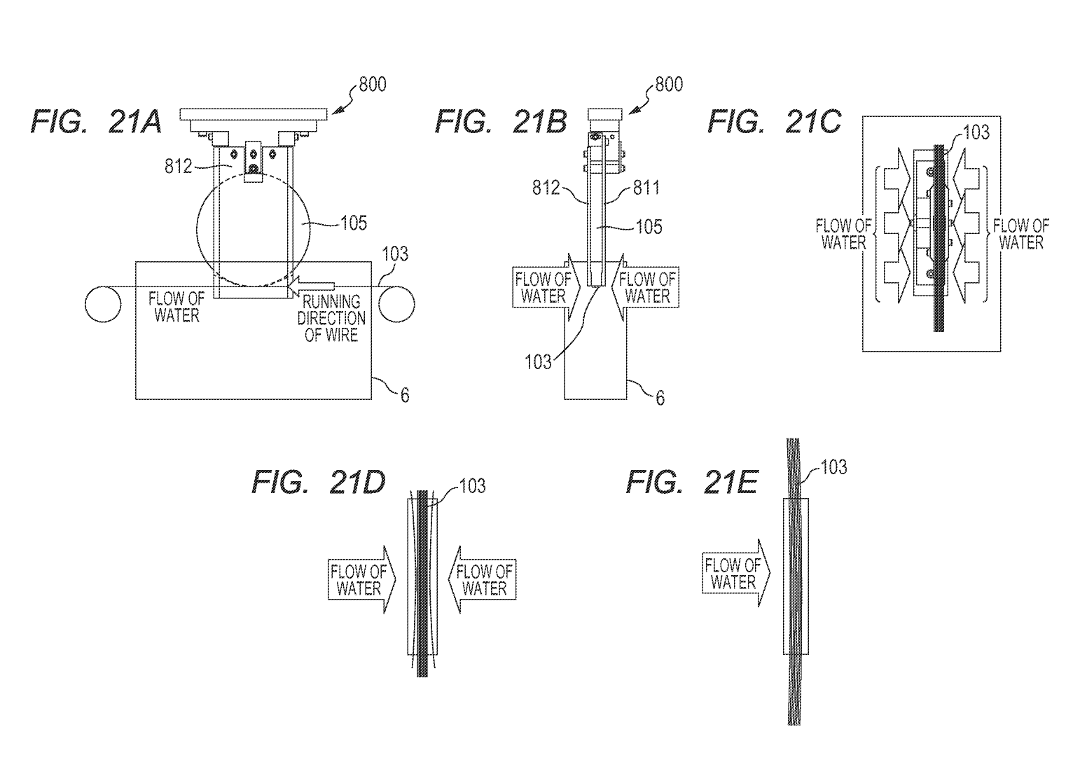

FIGS. 21A to 21E are referred to for description. FIGS. 21A to 21E illustrate a problem due to the influence of water flows when the holding units 811 and 812 are short. FIG. 21A is a front view illustrating the holding apparatus 800 for holding the ingot 105, the machining vessel 6 and the wire 103. FIG. 21B is a side view illustrating water flows in the machining vessel 6. FIG. 21C is a bottom view illustrating water flows in the machining vessel 6. FIG. 21D illustrates the wire 103 when there are water flows from both sides. FIG. 21E illustrates the wire 103 when there is a water flow from one side.

In a case as illustrated in FIG. 21A, the length of the wire to be exposed to the water flow is long at the beginning of the machining, and hence, influence of the water flow in a transverse direction with respect to the running direction of the wire 103 (in a direction in which the wires 103 are arranged in parallel) on the wire 103 is large. In other words, as illustrated in FIGS. 21B and 21C, in the machining vessel 6, the wire 103 is influenced by water flows in the transverse direction shown by arrows with respect to the running direction. Therefore, at the beginning of the machining, when there are water flows from both sides in the transverse direction against the wire 103, as illustrated in FIG. 21D, the wire 103 may be warped under the influence of the water flows from both sides in the transverse direction with respect to the running direction. Further, at the beginning of the machining, when there is a water flow from one side in the transverse direction, as illustrated in FIG. 21E, the wire 103 may be warped under the influence of the water flow from the one side in the transverse direction with respect to the running direction. Therefore, there are cases in which the running position and the layout of the wire 103 in the machining are displaced from an ideal position for slicing the ingot 105.

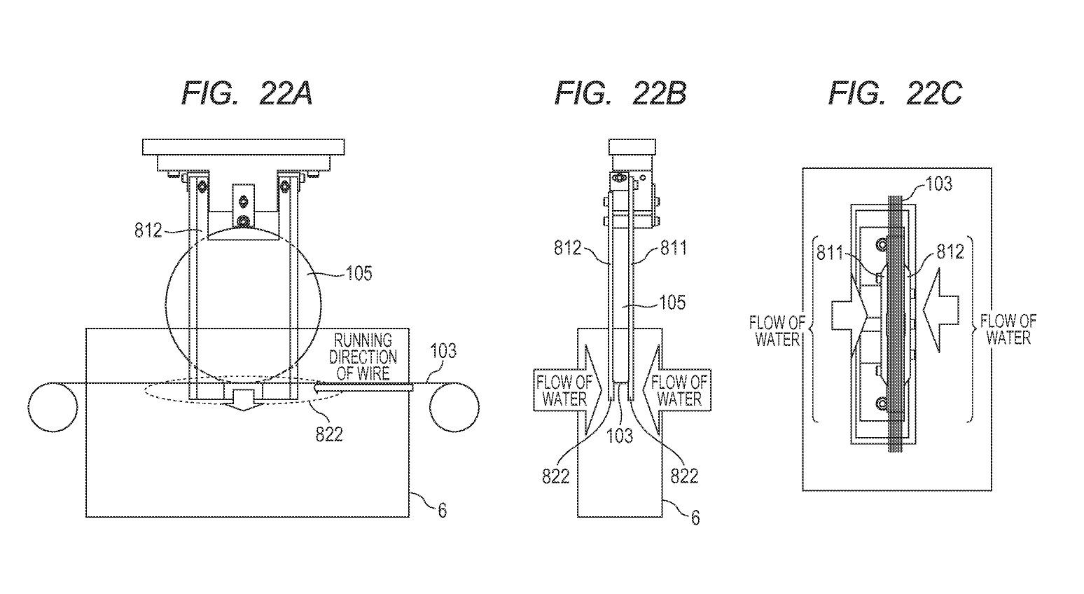

FIGS. 22A to 22C are referred to for description. FIGS. 22A to 22C illustrate the holding units 811 and 812 including area extended portions 822 for inhibiting influence of water flows in order to solve the above-mentioned problem due to a water flow. FIG. 22A is a front view of the holding apparatus 800 including the holding units 811 and 812 which are provided with the area extended portions 822 to be longer. FIG. 22B is a side view of the holding apparatus 800. FIG. 22C is a bottom view of the holding apparatus 800.

With reference to FIG. 22A, the holding units 811 and 812 have the area extended portions 822 surrounded by a broken line in the figure, and are extended downward to be longer than the holding units illustrated in FIG. 21A. In this case, at the beginning of the machining, as illustrated in FIGS. 22B and 22C, the wire 103 is surrounded by the area extended portions 822 of the holding units 811 and 812 in the transverse direction with respect to the running direction of the wire 103. Therefore, water flows from the transverse direction of the wire 103 can be blocked by the holding units 811 and 812 to reduce the influence of the water flows on the wire 103 at the beginning of the machining.

Note that, the ingot 105 may be a frustum-shaped, circular cylindrical, or rectangular prismatic ingot.

<Holding Apparatus 800 of Third Embodiment>

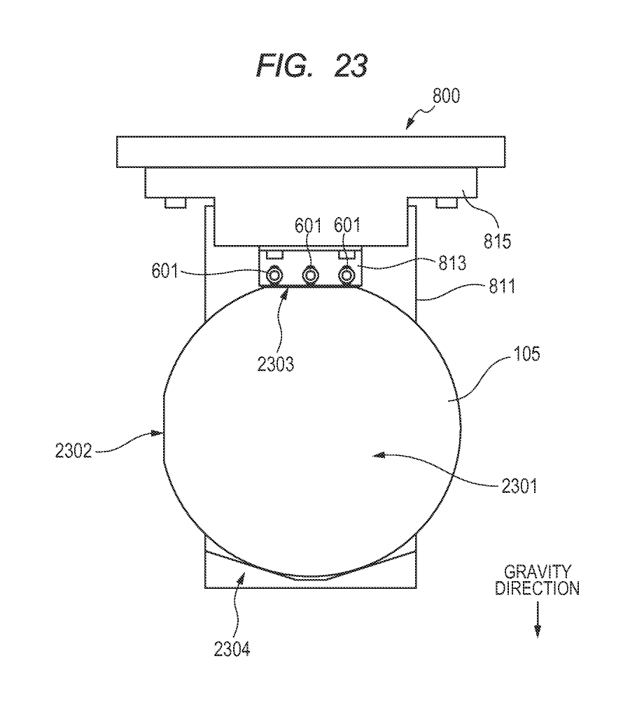

FIG. 23 to FIG. 25 illustrate the holding apparatus 800 according to a third embodiment of the present invention. The holding apparatus 800 of the third embodiment is a holding apparatus which can hold the ingot 105 that is dome-shaped.

FIG. 23 is referred to for description. FIG. 23 is a front view of the holding apparatus 800 which holds the dome-shaped ingot 105.

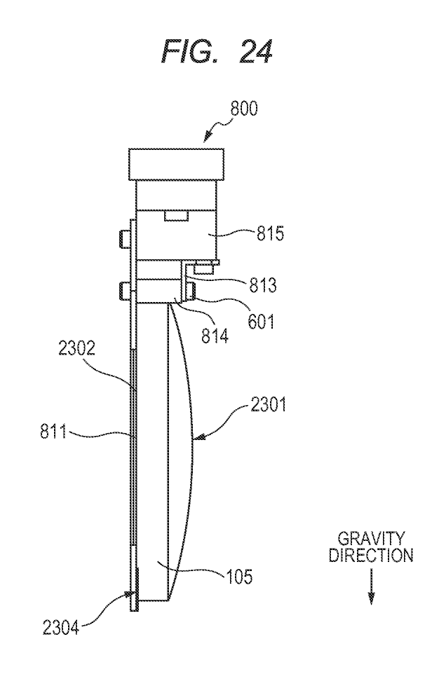

When an SiC crystal is formed in a crucible, an SiC ingot is grown in the crucible, and the grown SiC ingot is separated from the crucible. There are cases in which a portion separated from the crucible is polished to form a flat surface (a side in a flat shape of the ingot 105 illustrated in FIG. 24) 2302, and a periphery (circumferential surface) of the crystal is cut to be that of a circular cylinder, but a domical portion in a growth direction of the crystal (a dome-shaped side of the ingot 105 illustrated in FIG. 24) 2301 is not separated, and the ingot 105 formed in this way is sliced.

At that time, an orientation flat 2303 is provided based on a crystal orientation within the plane of the ingot 105. Electricity necessary for electrical discharge machining is supplied to the orientation flat 2303 using the ingot retaining roller 814 for supplying electricity. In this case, the ingot retaining roller 814 is formed of a material such as aluminum, SUS, or graphite. A plurality of ingot retaining rollers 814 may be provided using the screws 601 as illustrated in FIG. 23. The plurality of ingot retaining rollers 814 can retain the ingot 105 cut into slices (wafers) so as not to be separated by a water flow at the end of the machining of the ingot 105.

In addition, when the ingot 105 is mounted, the holding unit 811 can be bonded to the ingot 105 with a nonconductive adhesive. The holding unit 811 may be formed of a material such as aluminum or SUS. When the ingot 105 is mounted, by causing the ingot 105 to be caught on a claw 2304 of the holding unit 811 (side stay A), precision of reproducibility of the mounting position can be secured.

FIG. 24 is referred to for description. FIG. 24 is a side view of the holding apparatus 800 of the third embodiment.

The holding unit 811 retains (holds) the ingot 105 on one side. Note that, when a conductive adhesive is used when the ingot 105 is mounted to the holding unit 811, electricity for the machining can be supplied also from a portion of the holding unit 811 which retains the ingot 105. By placing the holding unit 811 so as to cover an entire surface of a portion of the ingot 105 which is in contact with the holding unit 811, nonuniformity in electricity supply can be avoided.

The retaining roller support plate 813 has an elongated hole provided therein for enabling adjustment of the height of the ingot retaining roller 814, and the height of the ingot retaining roller 814 can be changed to match the subtly different size of the ingot 105.

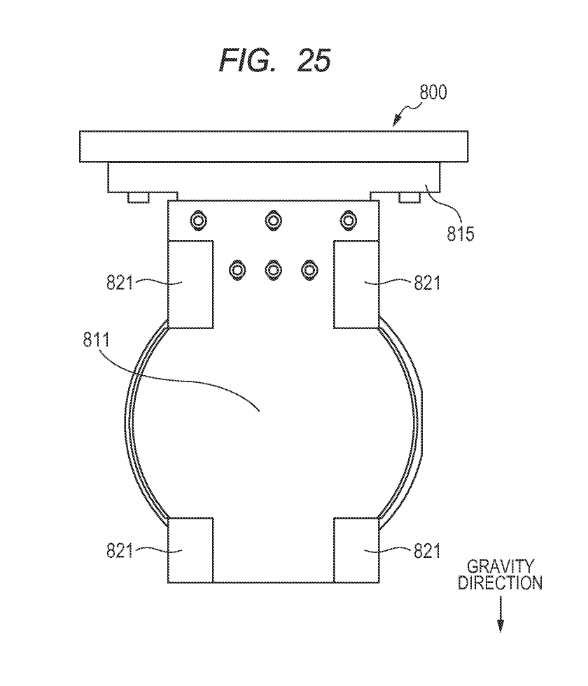

FIG. 25 is referred to for description. FIG. 25 is a rear view of the holding apparatus 800 of the third embodiment.

The slanted portions 821 as water flow avoiding portions for inhibiting the influence of a water flow on the wire 103 are provided on the holding unit 811 at portions which are adjacent to the wire 103 at the beginning of the machining and at portions which are adjacent to the wire 103 at the end of the machining. A role of the slanted portions 821 is to cause the water to flow in one direction with stability, and the slanted portions 821 can prevent a water flow from deviating (warping) the wire 103. At the beginning of the machining, the slanted portions 821 can prevent undulation of the wire 103 under the influence of a water flow to inhibit nonuniformity in distance between the wires when the slicing starts. At the end of the machining, the slanted portions 821 can inhibit deviation of the wire 103 under the influence of a water flow and dispersion of wafers when the slicing ends.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2013-155069, filed Jul. 25, 2013, No. 2013-243400, filed Nov. 25, 2013, and No. 2014-092913, filed Apr. 28, 2014 which are hereby incorporated by reference herein in their entirety.

What is claimed is:

1. A holding apparatus, which is used in electrical discharge machining for cutting a workpiece into slices at intervals of wires arranged in parallel to each other, the holding apparatus comprising:
a holding unit arranged to hold the workpiece so as to prevent the workpiece from falling from the holding apparatus; and
an energization unit arranged to energize the workpiece so as to pass current through the workpiece, wherein:
the holding unit is disposed outside a place at which the wires and the holding unit interfere with each other;
the energization unit is disposed at a place at which the cutting of the workpiece into slices by the wires ends; and
a portion of the energization unit, which is brought into contact with the workpiece at the place at which the cutting of the workpiece into slices ends, has a surface shape that is prevented from conforming to a machining surface of the workpiece which is cut into slices.

2. A holding apparatus according to claim 1, wherein, when the holding unit is absent in the holding apparatus, the energization unit itself is incapable of solely holding the workpiece so as to prevent the workpiece from falling.

3. A holding apparatus according to claim 1, wherein the portion of the energization unit, which is brought into contact with the machining surface of the workpiece has a shape that is prevented from being in surface contact with the machining surface.

4. A holding apparatus according to claim 1, further comprising an angle adjusting unit arranged to adjust a contact angle between the energization unit and the machining surface so that the contact portion of the energization unit conforms to an inclination of the machining surface.

5. A holding apparatus according to claim 1, wherein the holding apparatus is used for the electrical discharge machining of a cylindrical SiC ingot.

6. A holding apparatus according to claim 1, wherein, after the cutting into slices of the workpiece ends, wafers sliced at the intervals of the wires arranged in parallel to each other fall from the holding apparatus.

7. A holding apparatus according to claim 1, wherein:
the holding unit comprises a claw arranged to hold the workpiece so as to prevent the workpiece from falling; and
the claw enables the workpiece to be held so as to prevent the workpiece from falling without using an adhesive for fixing the workpiece to the holding unit on any border surface of the holding unit, which is brought into contact with the workpiece.

8. A method of holding a workpiece by using a holding apparatus used in electrical discharge machining for cutting the workpiece into slices at intervals of wires arranged in parallel to each other, the method comprising:
holding, by a holding unit of the holding apparatus, the workpiece so as to prevent the workpiece from falling from the holding apparatus; and
providing, by an energization unit of the holding apparatus, electrical continuity between the energization unit and the workpiece so as to pass current through the workpiece, wherein:
the holding unit is disposed outside a place at which the wires and the holding unit interfere with each other;
the energization unit is disposed at a place at which the cutting of the workpiece into slices by the wires ends; and
a portion of the energization unit, which is brought into contact with the workpiece at the place at which the cutting of the workpiece into slices ends, has a surface shape that is prevented from conforming to a machining surface of the workpiece which is cut into slices.

9. A wire electrical discharge machining apparatus for cutting a workpiece into slices at intervals of wires arranged in parallel to each other, the wire electrical discharge machining apparatus comprising:
a holding unit arranged to hold the workpiece so as to prevent the workpiece from falling; and
an energization unit arranged to energize the workpiece so as to pass current through the workpiece, wherein:
the holding unit is disposed outside a place at which the wires and the holding unit interfere with each other;
the energization unit is disposed at a place at which the cutting of the workpiece into slices by the wires ends; and
a portion of the energization unit, which is brought into contact with the workpiece at the place at which the cutting of the workpiece into slices ends, has a surface shape that is prevented from conforming to a machining surface of the workpiece which is cut into slices.

10. A method of machining a workpiece by using a wire electrical discharge machining apparatus for cutting the workpiece into slices at intervals of wires arranged in parallel to each other, the method comprising:
holding, by a holding unit of the wire electrical discharge machining apparatus, the workpiece so as to prevent the workpiece from falling; and
providing, by an energization unit of the wire electrical discharge machining apparatus, electrical continuity between the energization unit and the workpiece so as to pass current through the workpiece, wherein:
the holding unit is disposed outside a place at which the wires and the holding unit interfere with each other;
the energization unit is disposed at a place at which the cutting of the workpiece into slices by the wires ends; and
a portion of the energization unit, which is brought into contact with the workpiece at the place at which the cutting of the workpiece into slices ends, has a surface shape that is prevented from conforming to a machining surface of the workpiece which is cut into slices.
